(19) United States
(12) Patent Application Publication
(10) Pub. No.: US 2014/0304019 A1
(43) Pub. Date: Oct. 9, 2014

(54) MEDIA CAPTURE DEVICE-BASED ORGANIZATION OF MULTIMEDIA ITEMS INCLUDING UNOBTRUSIVE TASK ENCOURAGEMENT FUNCTIONALITY

(71) Applicant: Andrew C. Scott, Philadelphia, PA (US)

(72) Inventor: Andrew C. Scott, Philadelphia, PA (US)

(21) Appl. No.: 14/248,192

(22) Filed: Apr. 8, 2014

Related U.S. Application Data
(60) Provisional application No. 61/809,470, filed on Apr. 8, 2013.

(51) Int. Cl. G06Q 10/06

(52) U.S. Cl. CPC G06Q 10/063114; G06Q 10/0633
USPC 705/7.15

(57) ABSTRACT

In one embodiment, a processor-implemented method for encouraging a user of a computing device to perform a task. The task includes the user providing input to the computing device and is divisible into a plurality of portions performable by the user at different times. The method includes: (a) the processor dividing the task into a plurality of portions; (b) the processor waiting for one or more conditions to be satisfied; (c) after the one or more conditions are satisfied, the processor prompting the user to provide a response; and (d) after receiving the response from the user, the processor executing a software routine that enables the user to perform one of the portions of the task.

### CROSS-REFERENCE TO RELATED APPLICATION

This application claims priority to co-pending U.S. Provisional Patent Application Ser. No. 61/809,470, filed Apr. 8, 2013, the disclosure of which is incorporated herein by reference in its entirety.

### BACKGROUND

The disclosure relates, generally, to multimedia, and more particularly, to the capture, organization, and presentation of media items containing audio and/or visual elements.

Typically, media items (e.g., photographs, videos, and audio files) captured by individuals are organized into sets or albums long after they are captured on a mobile device (e.g., a digital camera or smartphone), and the organization process typically takes place on a separate device (e.g., a laptop or desktop computer), which may have more storage or computing resources or other advantages, such as a monitor with a larger viewing area, than the mobile device. Additionally, since the typical user must deal with a large number of multimedia items during the organization process, users often find themselves overwhelmed by the task and are reluctant to take steps to organize their captured media at all.

Conventionally, the organization of media items has been a cumbersome task not well suited for a mobile device.

### SUMMARY

Certain embodiments of the disclosure provide solutions to the foregoing problems and additional benefits, by providing devices, systems, and methods for organizing media items using a media capture device, such as a digital camera or smartphone, as well as a task encouragement scheme for breaking down a larger task into smaller portions that are more easily performed by a user and prompting the user to perform those smaller portions of the task in an unobtrusive manner.

In one embodiment, a processor-implemented method is provided for encouraging a user of a computing device to perform a task. The task includes the user providing input to the computing device and is divisible into a plurality of portions performable by the user at different times. The method includes: (a) the processor dividing the task into a plurality of portions; (b) the processor waiting for one or more conditions to be satisfied; (c) after the one or more conditions are satisfied, the processor prompting the user to provide a response; and (d) after receiving the response from the user, the processor executing a software routine that enables the user to perform one of the portions of the task.

In another embodiment, a system for encouraging a user to perform a task is provided, wherein the task includes the user providing input to a user interface of the system and is divisible into a plurality of portions performable by the user at different times. The system includes a user interface, a processor, and a non-transitory storage medium containing instructions for the processor. When the processor executes the instructions, the system is adapted to: (a) divide the task into a plurality of portions; (b) wait for one or more conditions to be satisfied; (c) after the one or more conditions are satisfied, prompt the user to provide a response; and (d) after receiving the response from the user, execute a software routine that enables the user to perform, via the user interface, one of the portions of the task.

In a further embodiment, a non-transitory machine-readable storage medium is provided, having encoded thereon program code. When the program code is executed by a machine, the machine implements a method for encouraging a user of a computing device to perform a task. The task includes the user providing input to the computing device and is divisible into a plurality of portions performable by the user at different times. The method includes: (a) dividing the task into a plurality of portions; (b) waiting for one or more conditions to be satisfied; (c) after the one or more conditions are satisfied, prompting the user to provide a response; and (d) after receiving the response from the user, executing a software routine that enables the user to perform one of the portions of the task.

### BRIEF DESCRIPTION OF THE DRAWINGS

FIG. 1 is a block diagram of an exemplary digital camera, in one embodiment of the disclosure;

FIG. 2 shows a rear perspective view of the camera of FIG. 1, in one embodiment of the disclosure;

FIG. 3 is a Set Name selection screen view of the camera of FIG. 1, in one embodiment of the disclosure;

FIG. 4 is a Subset Name selection screen view of the camera of FIG. 1, in one embodiment of the disclosure;

FIG. 5 is a viewfinder screen view of the camera of FIG. 1, in one embodiment of the disclosure, showing Set Name and Subset Name selections;

FIG. 6 is a tag selection screen view of the camera of FIG. 1, in one embodiment of the disclosure;

FIG. 7 is a tag selection screen view of the camera of FIG. 1, in another embodiment of the disclosure;

FIG. 8 is a Set Name selection screen view of the camera of FIG. 1 employing speech recognition, in one embodiment of the disclosure;

FIG. 9 is an Audio Caption recording screen view of the camera of FIG. 1, in one embodiment of the disclosure;

FIG. 10 is a Comments entry screen view of the camera of FIG. 1, in one embodiment of the disclosure;

FIG. 11 is a “shot packet” creation screen view of the camera of FIG. 1, in one embodiment of the disclosure;

FIG. 12 is a Text Caption entry screen view of the camera of FIG. 1, in one embodiment of the disclosure;

FIG. 13 is a viewfinder screen view of the camera of FIG. 1, in one embodiment of the disclosure, showing a Text Caption;

FIG. 14 is a Text Caption customization screen view of the camera of FIG. 1, in one embodiment of the disclosure;

FIGS. 15 and 16 are Sequences creation/editing screen views of the camera of FIG. 1, in one embodiment of the disclosure;

FIG. 17 is an exemplary order of photographs for a slide show;

FIG. 18 an exemplary metadata modification screen view of the camera of FIG. 1, in one embodiment of the disclosure;

FIG. 19 is an exemplary media import screen view of the camera of FIG. 1, in one embodiment of the disclosure;

FIG. 20 is an exemplary media processing module main menu screen view of the camera of FIG. 1, in one embodiment of the disclosure;

FIG. 21 is an exemplary media item browsing/metadata editing screen view of the camera of FIG. 1, in one embodiment of the disclosure;

FIG. 22 is an exemplary task encouragement module modal window of the camera of FIG. 1, in one embodiment of the disclosure; and

FIG. 23 is a flowchart for an exemplary method performed by a task encouragement module, in one embodiment of the disclosure.

### DETAILED DESCRIPTION

The following description sets forth various exemplary embodiments of capture device-implemented systems and methods for creating virtual photo and video albums, facilitated by the use of metadata stored for captured media. Embodiments of the disclosure permit a user to group and label media items in convenient ways, and those labels can be used as keywords for searching, indexing, or arranging the media items and/or as captions or titles that appear during subsequent presentation of the media items. Embodiments of the disclosure also provide a number of additional features, which may include, e.g.: the naming of sets of shots (i.e., photographs and/or video clips) in a camera application prior to shooting; the specification of “shot packets” within a set; being able to group shots from diverse sources across the web into a virtual set; using Sequence Numbers to create and specify the order of various different subsets of shots, rather than having to physically move the shots using a method such as drag-and-drop; creating unusual graphic, animated and/or video background wallpaper over which shots are exhibited, as well as picture and video frames of varied graphic patterns; combining the editing and exhibition processes; providing an automated process in which algorithms assemble available photos, video, and audio on the fly; and providing a task encouragement scheme for breaking down a larger task into smaller portions that are more easily performed by a user and prompting the user to perform those smaller portions of the task in an unobtrusive manner.

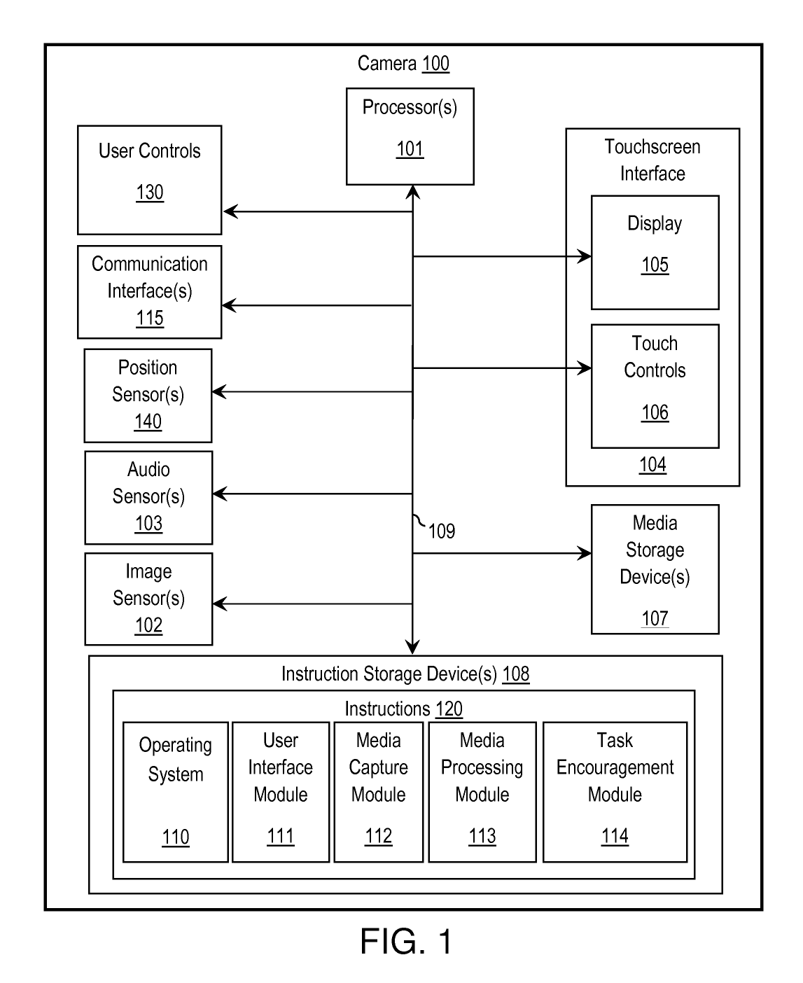

FIG. 1 shows a block diagram of an exemplary digital camera 100, in one embodiment of the disclosure. FIG. 1 illustrates only one particular example of camera 100, and many other example configurations of camera 100 exist. It should be recognized that camera 100 could also be a video camera, a mobile phone, tablet computing device, portable media player, laptop or desktop computer, a television, and/or any other device or combination of devices used in concert, constructed so as to be able to achieve the functionality discussed herein.

In this embodiment, camera 100 includes one or more processors 101, one or more image sensors 102, one or more audio sensors 103, a touchscreen interface 104 having a display 105 and touch controls 106, one or more media storage devices 107, one or more instruction storage devices 108, one or more communications interfaces 115, one or more user controls 130, one or more position sensors 140, and one or more communication channels 109. Camera 100 may include one or more additional components not specifically shown in FIG. 1, such as physical buttons, speakers, other interfaces or communication ports, additional storage devices, or the like.

Communication channels 109 physically, communicatively, and/or operatively interconnect each of components 101, 102, 103, 105, 106, 107, 108 for inter-component communications and may include a system bus, a network connection, an inter-process communication data structure, and/or any other method for communicating data.

Image sensors 102 include at least one lens positioned to focus light reflected from one or more objects in a scene onto a plurality of photosensitive cells in a charge-coupled device (CCD), a complementary metal oxide semiconductor (CMOS) sensor, or the like, when a shutter is open, for image exposure. Image sensors may also include image-processing logic that receives electrical signals representative of the light captured during exposure to generate a digital image, which are stored on one or more internal or external media storage devices 107 (e.g., a removable flash memory card). Camera 100 produces digital images, such as photographs (or “photos”) and moving videos (collectively referred to herein as “shots”), which are stored as digital image files using media storage devices 107. Camera 100 also produces motion video images, such as video recordings, by capturing sequences of digital images and recording those sequences in a digital video file. The phrase “digital image” or “digital image file,” as used herein, refers to any digital image file, such as a digital still image or a digital video file.

Audio sensors 103 include at least one microphone or array of microphones positioned to record sound, which may be stored in the form of digital audio files on media storage devices 107. The digital audio files may be recorded and stored concurrently with the capture of photographs and/or video recordings by image sensors 102 to create multimedia files, such as video recordings with sound. The digital audio files may be integrated with, or maintained separately from, the digital image files containing the photograph or motion video data.

In some embodiments, camera 100 is adapted to capture motion video images with or without audio, still images, and audio. Camera 100 can also include other functions, including, but not limited to, the functions of a digital music player (e.g. an MP3 player), a mobile telephone, a GPS receiver, and/or a programmable digital assistant (PDA).

Image sensors 102, audio sensors 103, media storage devices 107, and the processing logic for capturing and storing photographs and audio and video recordings are well-understood in the camera and photography arts, and detailed descriptions thereof are not necessary for a complete understanding of this disclosure.

Touchscreen interface 104 provides a graphical user interface (GUI) that serves as both (i) a user interface device configured to receive user inputs, such as touch inputs received via touch controls 106, and (ii) a display 105, such as by presenting images and text to the user via a user interface composed of one or more physical display devices.

In some implementations, touch controls 106 may be “presence-sensitive” or “touch-sensitive,” so as to be able to detect the presence of an input object, such as a finger or stylus, when the input object is sufficiently close to touch controls 106. Touch controls 106 may be implemented using various technologies, including, e.g., a resistive touchscreen, a surface acoustic wave touchscreen, a capacitive touchscreen, a projective capacitance touchscreen, an acoustic pulse recognition touchscreen, or another touchscreen technology. In some embodiments, touch controls 106 may be able to detect the presence of an input object without the input object physically touching touch controls 106, when the input object is sufficiently close to touch controls 106 to be detectable. In some embodiments, camera 100 may include, or may be communicatively coupled to, a display device and a user interface device that is not integrated with the display device but still detects the presence of one or more input objects.

Instead of or in addition to employing touch controls implemented in a touchscreen, some functions of camera 100 may be controlled via other types of user controls 130 (e.g., a physical shutter-release button), which may include a variety of other types of input devices, such as a keyboard, keypad, one or more buttons, rocker switches, joysticks, rotary dials, or the like.

Display 105 provides an output for a graphical user interface (GUI) for camera 100 and may include, e.g., a liquid crystal display (LCD), an active-matrix organic light-emitting diode (AMOLED) display, or the like. In general, a GUI may be a type of user interface that allows a user to interact with a camera or other computing device that includes at least one image, and typically also includes one or more character strings.

Collectively, camera 100 may receive control input from a human user via multiple user-input devices, including, e.g., receiving tactile controls via touch controls 106 of touchscreen 104 and voice commands received via audio sensors 103 and processed using speech-recognition techniques. Such input may include not only tactile (including handwriting recognition and gesture input) and audio input, but may further include, e.g., image or video input from image sensors 102, in some embodiments.

Position sensors 140 may include one or more Global Positioning System (GPS) receivers, accelerometers, and/or other devices suitable for determining location and/or movement of camera 100.

Communication interfaces 115 provide file and data-transfer capabilities between camera 100 and one or more external devices, e.g., via a wired or wireless connection, or via a communications network, such as a local area network or the Internet. Communication interfaces 115 may include wireless transmitters and receivers that enable camera 100 to communicate wirelessly with a communications network and processing circuits and memory for implementing file transfer agent functions and controlling communications. Communication interfaces 115 may include a serial or parallel interface, such as a Universal Serial Bus (USB) interface, a Firewire interface, or the like. Communication interfaces 115 may enable long-range communication over a wide-area network (WAN), local-area network (LAN), or wireless telephonic network and may include a standard cellular transceiver, such as a GSM or CDMA transceiver. Communication interfaces 115 may include one or more of: a WiFi or WiMAX transceiver, an orthogonal frequency-division multiplexing (OFDM) transceiver, and a Bluetooth, RFID, or near-field communications (NFC) transceiver.

Instruction storage devices 108 store information used during the operation of camera 100. Instruction storage devices 108 are, in this embodiment, primarily a short-term computer-readable storage medium, although instruction storage devices 108 may include long-term storage media. Instruction storage devices 108 comprise volatile memory, e.g., random-access memories (RAM), dynamic random-access memories (DRAM), static random-access memories (SRAM), or the like, whose contents are lost when camera 100 is powered off. To retain information after camera 100 is powered off, instruction storage devices 108 may further be configured for long-term storage of information as non-volatile memory, e.g., magnetic hard discs, optical discs, floppy discs, flash memories, or forms of electrically programmable memories (EPROM) or electrically erasable and programmable (EEPROM) memories.

Processors 101 read and execute instructions 120 stored by instruction storage devices 108. Execution of instructions 120 by processors 101 configures or causes camera 100 to provide at least some of the functionality described herein. Processors 101 include one or more electronic circuits implanted, e.g., as a microprocessor, digital signal processor, Application Specific Integrated Circuit (ASIC), Field Programmable Gate Array (FPGA), Programmable Logic Device (PLD), or the like.

Instructions 120 stored by instruction storage devices 108 include operating system 110, user interface module 111, and a plurality of application modules, namely, media capture module 112, media processing module 113, and task encouragement module 114.

User interface module 111 contains instructions for maintaining and managing the graphical user interface (GUI) on touchscreen interface 104, including items displayed on display 105 and input received via touch controls 106. The GUI includes various user-selectable control elements, including, e.g., various camera modes, such as video capture mode, still capture mode, and review mode, and the initiation of capture of still images, the recording of motion images, and audio capture. Touchscreen interface provides a GUI with touch controls 106 having one or more touch-sensitive user-control elements in the form of a touchscreen overlay on display 105.

Execution of instructions in operating system 110 and user interface module 111 may cause camera 100 to perform various functions to manage hardware resources of camera 100 and to provide various services common to modules 112, 113, and 114. Execution of instructions in application modules 112, 113, and 114 may cause camera 100 to provide various applications and/or other functionality, as will be discussed in further detail below.

Media capture module 112 contains instructions to effect the taking of photographs, videos recordings, audio recordings, and combinations of one or more of the foregoing. Media capture module 112 includes instructions for presenting a camera interface with camera controls to the user and receiving user input to control camera functionality.

Media processing module 113 contains instructions to effect the processing of media that has already been captured, including editing, labeling, organizing, arranging, exhibiting, and/or exporting media items in the form of a slideshow or other presentation, and related functionality.

Task encouragement module 114 contains instructions for reminding the user of a media-processing task that has not yet been completed, such as using push notification methods. Task encouragement module 114 also contains instructions for presenting the user with an opportunity to complete part or all of that task with little interruption to the user, and in a way that is as unobtrusive and non-burdensome as possible.

The functionality of camera 100 will now be described in further detail. Such functionality is implemented in program code (e.g., firmware and/or software) embodied in the various instructions 120 of camera 100 and executable by processors 101. Although specific references to each of operating system 110, user interface module 111, media capture module 112, media processing module 113, and task encouragement module 114 will not necessarily be made in every instance in the following description, it should be recognized that collectively, these instructions 120 effect the functionality that will now be described. As one example, during the process of taking a photograph or video recording, media capture module 112 employs associated functionality of user interface module 111 to receive user input from touch controls 106 and to provide output to the user via display 105. However, in certain portions of the following description, only exemplary screen views are provided, together with a description of the inputs received from the user and outputs provided to the user. It should nevertheless be understood that operating system 110 and user interface module 111 are employed during this process to perform the appropriate functionality to effect such user inputs and outputs, as controlled by the instructions of media capture module 112.

It should also be understood that the functionality described herein is not intended to be limiting, nor limited only to use with camera 100. Other embodiments of cameras that may implement such functionality are also contemplated, and other cameras implementing alternative or additional functionality are also contemplated. Although, for clarity, the following discussion will relate primarily to the capturing of photographs and the resulting image files, unless otherwise noted, it should be assumed that the operations discussed are equally applicable to other types of media capture and the corresponding resulting media files, including audio files and motion video images with or without audio.

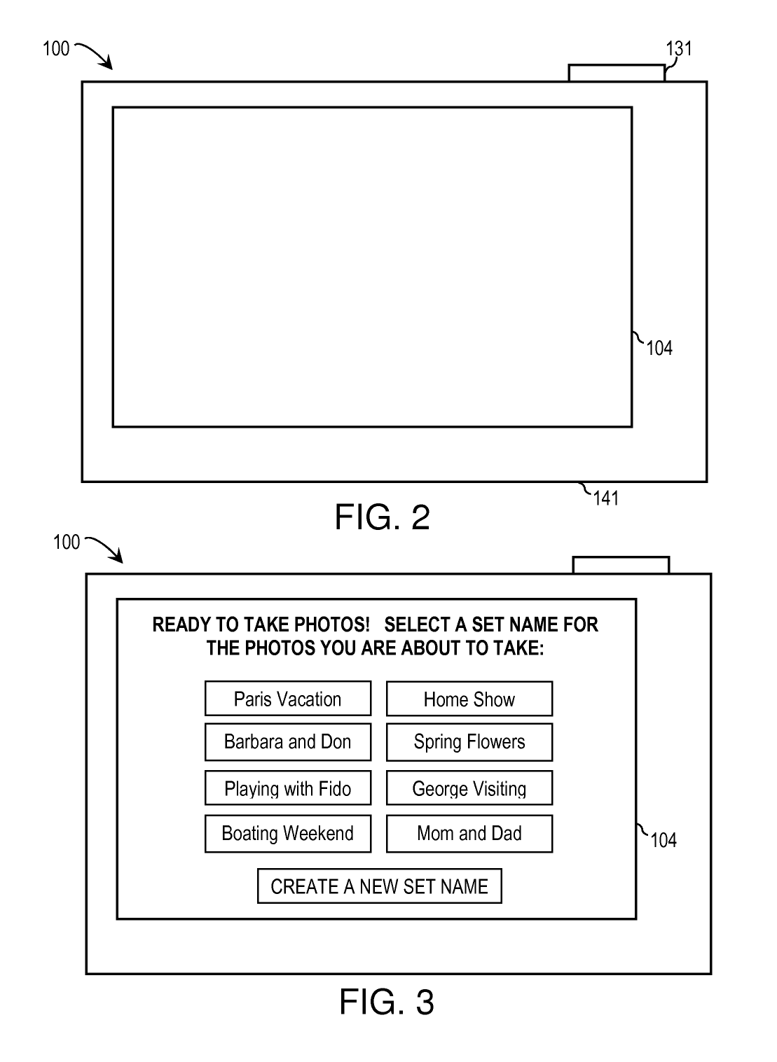

FIG. 2 shows a rear perspective view of camera 100, showing touchscreen interface 104, and also showing a shutter-release button 131 on the housing 141 of camera 100 that forms part of user controls 130.

The present disclosure introduces the concept of multi-level hierarchical groupings of media items, which will be referred to herein using the terms “sets” and “subsets.” For example, for media items that are photographs, sets and subsets would be analogous to the conventional concept of albums, i.e., photographs that have some connection with respect to content, date, time, place, or some other element or elements. In some embodiments of the disclosure, the opportunity is given to the user to group photographs (and/or other media items) into sets and subsets as they are being captured, to save time having to return to those items to organize them later into albums.

### Media Capture Module

Exemplary modes of operation of media capture module 112, in one embodiment of the disclosure, will now be described with reference to FIGS. 3-20.

As discussed above, media capture module 112 is adapted to effect the appropriate functionality for capturing photographs, recording video or audio, and the like, and detailed descriptions of such basic functionality are not necessary for a complete understanding of this disclosure. However, to the extent media capture module 112 functions differently from that of a conventional digital camera, video recorder, or the like, such differences will be discussed below.

As shown in FIG. 3, in one embodiment, prior to the user beginning to shoot photographs, media capture module 112 presents the user with an on-screen selection of an already-used Set Name from a list, and the photos subsequently taken will be assigned that Set Name. Alternatively, the user can select an option to create a new Set Name, which permits the user to enter (e.g., via an on-screen overlay keyboard on touchscreen 104) an alphanumeric Set Name for a set of photos about to be taken. Each photo that is subsequently taken is stored (e.g., on media storage devices 107) along with the Set Name to which it belongs. It should be understood that the storage of photographs (or other media files or items) and their corresponding Set Names (and/or other metadata that will be described herein, including Subset Names, Tags, Subtags, Time, Date, Location, Sequence Numbers and Names, Comments, Text Captions, and so forth) may be effected via one or more relational or non-relational databases, or alternatively, such metadata may be embedded into (e.g., using EXIF-formatted data), concatenated with, or otherwise stored in conjunction with the media files or items themselves. In one embodiment, metadata is stored in a database on media storage devices 107, separately from the media files or items themselves.

Current smartphone and camera technology, which permits connection to the Internet, e.g., via Wi-Fi or a mobile phone account, permits photos and videos to be taken and uploaded to a cloud facility automatically, such as to back up the same images stored on a memory device residing on the device taking the shots. Some photo storage cards provide such functionality as well. In certain embodiments, such features are employed so that the photographs (or other media items) themselves and/or their corresponding Set Names/Subset Names, and other metadata are provided via communications interface(s) 115 for storage on one or more servers using a cloud-storage, LAN-storage, WAN-storage, or other networked-storage or remote-storage method. In addition to backing up or mirroring media items and metadata, in some embodiments, camera 100 may be adapted to back up slideshows, shot packets, sequences, sets, subsets, and other groupings of media to storage on one or more servers using a cloud-storage, LAN-storage, WAN-storage, or other networked-storage or remote-storage method.

In one embodiment, camera 100 automatically duplicates media items and the working database of metadata and media filenames & locations to one or more remote locations, e.g., another device associated with the user (e.g., a networked laptop or desktop computer via a WiFi connection), a remote file server or cloud-storage service, such as DropBox, or the like. The database is desirably duplicated only after camera 100 confirms that the media items associated with the database have already been successfully moved, so that the database can first be updated with the new, additional location of the media. In addition to providing backup capabilities, this configuration provides the ability for a user to interact with the database at a variety of physical locations and/or using multiple devices (other than camera 100 itself), where those devices are configured in like manner to camera 100, employing application modules such as media capture module 112, media processing module 113, and task encouragement module 114. Thus, media items can be captured using camera 100, while media processing takes place on a desktop computer at a different location using the shared database stored on the remote file server. Camera 100, in such embodiments involving remote file server and/or cloud server storage, also permits media items and/or the database to be re-imported, in the event that such items or files are modified in their new location, or, for example, if a local system crash occurs, and the local version must be reconstructed. In some embodiments, camera 100 can select an appropriate location from which to read media files (e.g., either media storage devices 107 or a remote file server), based on proximity to the controlling software and availability. In one embodiment, the order of preference is: first, the same device running the software; next, a device on the same LAN or connected via WiFi; or third, a server on the Internet.

Once a Set Name has been selected, that Set Name persists for all photographs that are subsequently taken until the user modifies the Set Name to a different Set Name or turns off the Set Name. However, in some embodiments, a user may be required to have at least a default Set Name assigned to all media items, or a Set Name that is automatically generated based on an algorithm that uses one or more of time, date, and GPS information from position sensors 140, for example.

In some embodiments, the Set Name is a tag, metatag, or keyword used for searching or indexing the photographs at a later time (however, a separate Tag Name field can alternatively or additionally be used for this purpose, as will be discussed in further detail below). Alternatively or additionally, the Set Name may be used as a caption or title that is intended to appear as a visual element during the subsequent presentation of the photographs, in or near the photographs (however, a separate Text Caption field can alternatively or additionally be used for this purpose, as will be discussed in further detail below). In other embodiments, the Set Name may be an Apple-format “album,” such that media tagged with the same Set Name will be grouped in the same album, when imported into Apple software, e.g., in the Apple iPhoto software program. In the Apple album scenario, the album name could be specified as (i) a concatenation of one or more metadata items, such as Tags (discussed in further detail below); (ii) the Set Name itself, or (iii) a custom name manually entered by the user.

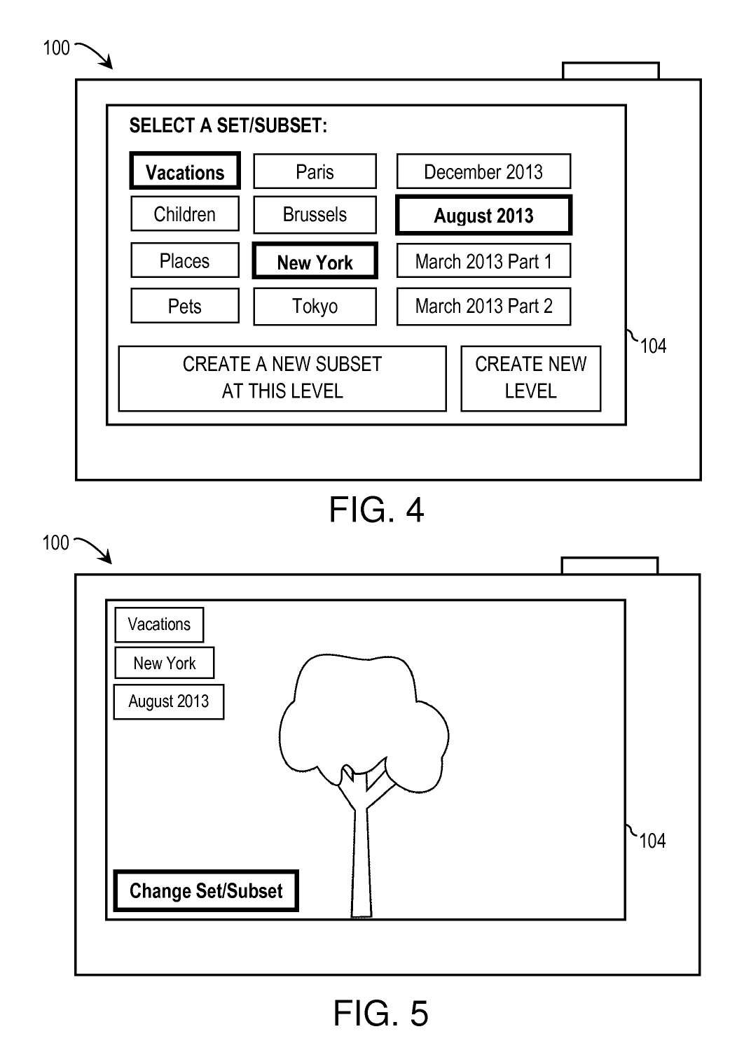

As shown in FIG. 4, in some embodiments, users are permitted to assign further divisions of sets (and, hence, Set Names) into one or more hierarchical levels of subsets (and hence, one or more hierarchical levels of Subset Names). The user can select an option to create a new Subset Name at any level, which permits the user to enter (e.g., via an on-screen overlay keyboard on touchscreen 104) an alphanumeric Subset Name for a set of photos about to be taken. In some embodiments, users may create as many further levels of subsets as storage permits, by using a “Create New Level” button. In this example, the user has selected the Set Name “Vacations,” which presents a list of cities that the user has previously set up as a first-level Subset Names. Once the user selects “New York” as a city, the user is presented with a list of second-level Subset Names that the user has previously set up for four different subsets of photographs of New York trips.

It should be understood that, in some embodiments where one or more levels of Subset Names are employed, each photograph is automatically associated not only with the lowest-level Subset Name selected (in this example, August 2013), but also with all of its parent Subset Names and Set Name in the hierarchy (i.e., New York and Vacations, respectively). Thus, if a user is subsequently searching for a photograph that has been tagged with “August 2013,” the photograph would appear not only in the results of a search for the Subset Name “August 2013,” but also in a search for the Set Name “Vacations” and in a search for the Subset Name “New York.”

The lists of Set Names and/or Subset Names may be provided to the user in a manner that makes the selection process as quick as possible for the user. For example, Set Names and/or Subset Names may be presented in order of most frequently selected, or most recently used, or via other mechanisms such as a drop-down list. In one embodiment, the user can select Set Names and/or Subset Names to populate custom “quick menus” that permit the user to quickly change among often-used Set Names and/or Subset Names of the user's choice. Set Names and/or Subset Names can also be assigned to keyboard keys or similar shortcut methods in certain embodiments, for subsequent faster selection.

As shown in FIG. 5, in one embodiment, at all times during media capture, the current Set Name and Subset Name(s) are displayed, to ensure that the user intends for the photographs being taken to be assigned to the set and any subset(s) that were last selected. A button is provided for the user to change to a different Set Name and/or Subset Name(s) for subsequent photographs that are taken.

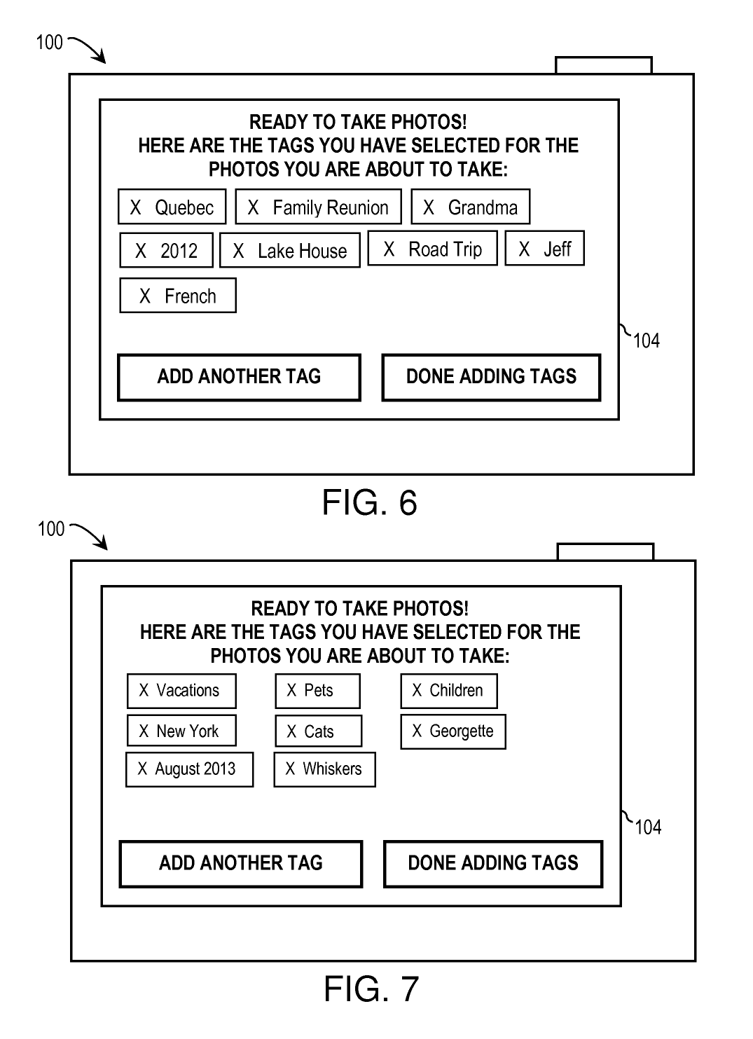

In one embodiment, a single photograph can be associated with more than one Set Name, and the user is presented with options for adding additional Set Names after one Set Name has been selected. As shown in FIG. 6, in this embodiment, the Set Name field is referred to by the commonly-used term “tag” in the user interface, presenting a concept that many users will already understand from the context of tagging photos in social media settings. Permitting multiple Set Names to be assigned to a single photo (or other media item) allows Set Name to be used, for example, as an assignable field for “tagging” a photo with multiple tags (as only limited by storage) to identify individuals, themes, objects, geographic locations, dates/times, or the like, associated with or appearing in the photo. Selecting multiple Set Names for a photo that function as tags or metatags permits that photo to be later searched, indexed, grouped, and organized using any one or more of those tags. In this example, the user has selected the tags “Quebec,” “Family Reunion,” “Grandma,” “2012,” “Lake House,” “Road Trip,” “Jeff,” and “French,” and all of those tags are stored as Set Names with each photo subsequently taken. In this exemplary interface, the user can remove tags by touching an “X” displayed inside each tag. The user is also presented with buttons for adding additional tags (e.g., using an interface similar to that shown in FIG. 3) and to indicate when the user has finished adding tags.

As shown in FIG. 7, in one embodiment, a single photograph can be associated with more than one Subset Name, and the user is presented with options for adding additional Subset Names after one Subset Name has been selected. As with the embodiment of FIG. 6, in this embodiment, the Subset Name field is referred to by the commonly-used term “tag” in the user interface, presenting a concept that many users will already understand from the context of tagging photos in social media settings. The association between a single photograph (or other media item) and multiple Subset Names is similar to the association with Set Name discussed above with reference to FIG. 6. However, the principal difference is that, in the embodiment of FIG. 7, each photograph is automatically associated not only with the lowest-level multiple Subset Names selected (in this example, August 2013, Whiskers, and Georgette), but also with all of their respective parent Subset Names and Set Names in the hierarchy (i.e., New York and Vacations; Cats and Pets; and Children). Thus, a photograph for which the user has “tagged” (or selected the subsets) August 2013, Whiskers, and Georgette would appear not only in the results of searches for “August 2013,” “Whiskers,” and “Georgette,” but also in searches for the Set Names “Vacations,” “Pets,” and “Children,” as well as in searches for the Subset Names “New York” and “Cats.”

Instead of, or in addition to, populating Set Name and/or Subset Name with tagging-type metadata in the manner described above, alternative embodiments employ separate Tag Name and/or Subtag Name metadata fields for this same purpose, for example, to permit the concurrent use of Set Name for a purpose other than tagging, such as captioning or album grouping. In this scenario, operation and functionality with respect to Tag Name and/or Subtag Name is substantially as described above for Set Name and/or Subset Name.

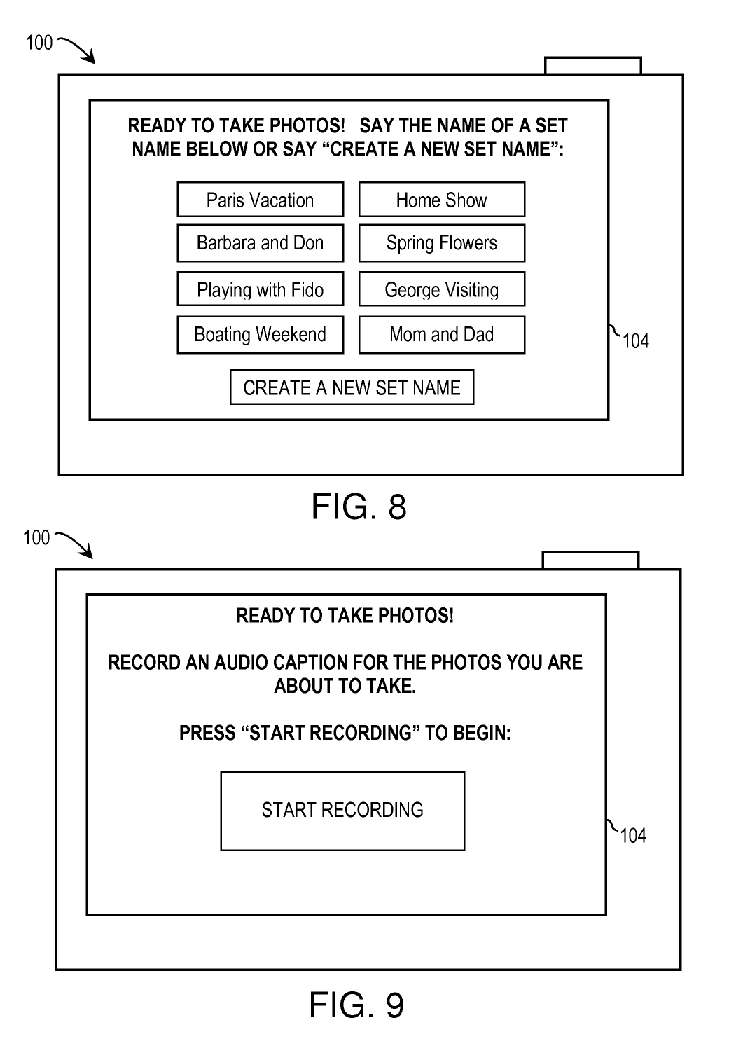

As shown in FIG. 8, in one embodiment, the user selects and/or enters Set Names and/or Subset Names using audio sensors 103, and the user's speech input is processed using speech-recognition techniques. For entry of new alphanumeric Set Names and/or Subset Names, the user's speech input is converted to text. In some embodiments, audio sensors 103 are also used for receiving speech commands from the user. For example, in an input scenario where the user is selecting a Subset Name (or selecting a Set Name, or entering a Text Caption, as will be discussed below, or the like), the user issues a verbal instruction, such as, “New Subset Name ‘Baseball Game,’” and “Baseball Game” is added as a new Subset Name and is selected for the photographs about to be taken.

As shown in FIG. 9, audio sensors 103 may be used to record an Audio Caption (e.g., a photographer's voice narration) to accompany one or more photographs. The Audio Caption is stored as metadata along with the Set Name for each photograph and may later be played back, e.g., as part of an audio track to accompany a slide presentation of the photographs during exhibition. Like Set Name and Subset Name, Audio Caption is a metadata element that persists for all photographs that are subsequently taken until the user modifies the Audio Caption to a different Audio Caption or turns off the Audio Caption.

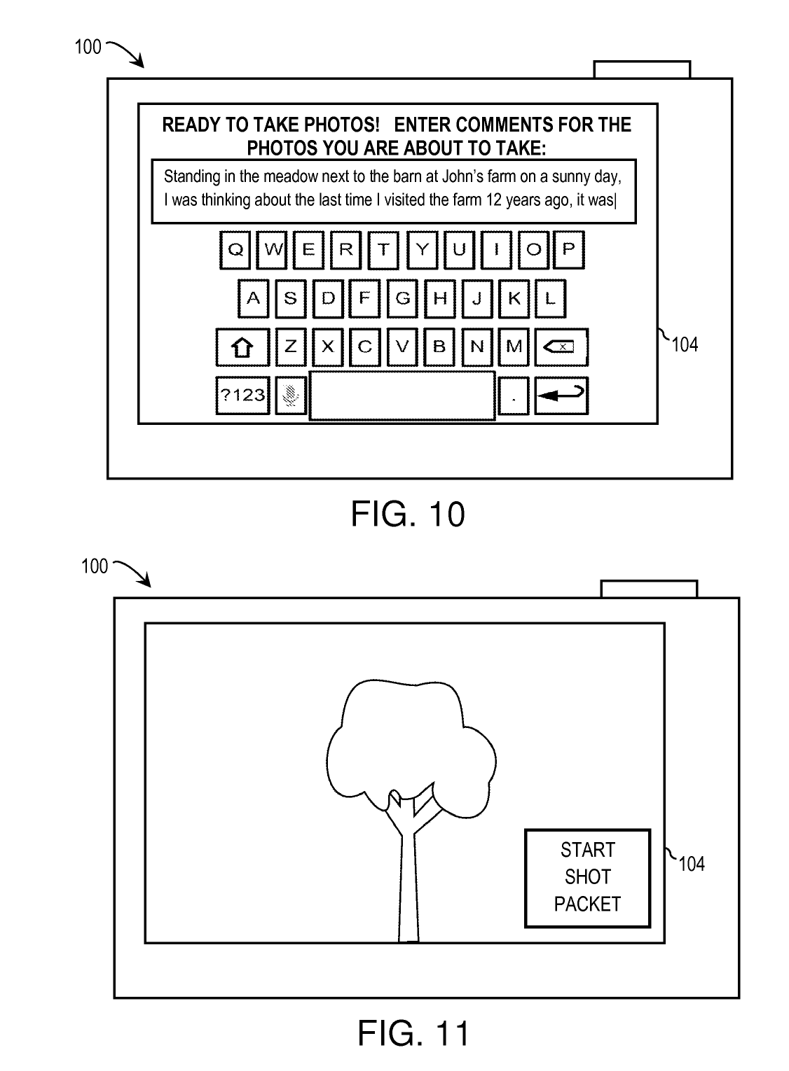

As shown in FIG. 10, one or more text-entry fields may be presented to the user for entry of optional additional Comments (or notes, or the like) to permit more verbose descriptions, particularly in embodiments where a Set Name is used primarily as a tag and not a lengthy field that permits suitable descriptions. These Comments are stored as metadata along with the Set Name for each photograph, and the user can later choose whether or not to display Comments during display of media items (e.g., during browsing, during slideshows, and so forth) by selecting a “Hide/Show Comments” button (not shown), or the like. As shown, a button (shown here as a microphone icon) may be provided on an overlay keyboard to toggle between on-screen keyboard text entry and voice-recognition text entry. Searches can be performed for photographs (or other media) using text in associated stored Comments, just as with Set Names and/or Subset Names.

Instead of, or in addition to, populating Set Name and/or Subset Name with titling or captioning-type metadata as described above, alternative embodiments employ a separate Text Caption metadata field for this same purpose, for example, to permit the concurrent use of Set Name for a purpose other than captioning or titling, such as tagging or album grouping. In this scenario, operation and functionality of the Text Caption metadata field is substantially as described above for the Comments metadata field, except that Text Captions will generally be less verbose than Comments in most embodiments.

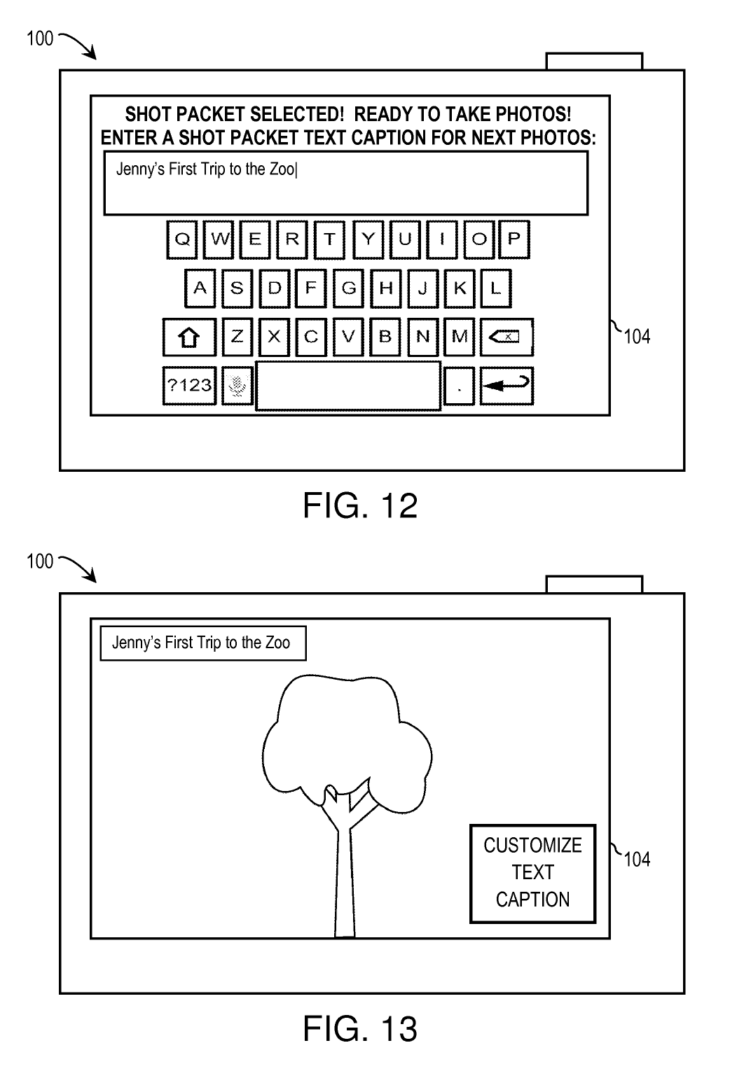

Using an interface such as that shown in FIG. 12, a text-entry field may be presented to the user for entry of an optional additional Text Caption, which is intended to appear as a visual element during the subsequent presentation of the media item, in or near the media item. The Text Caption is stored as metadata along with the Set Name for each photograph, and the user can later choose whether or not to display Text Captions during display of media items (e.g., during browsing, during slideshows, and so forth) by selecting a “Hide/Show Text Captions” button (not shown), or the like. Searches can be performed for photographs (or other media) using text in associated stored Text Captions, just as with Set Names and/or Subset Names.

As photographs are taken (or other media items are captured), the time, date, and location (as determined via GPS) of each photograph is stored as corresponding metadata. Accordingly, Audio Captions, Text Captions, and Comments that are stored with those photographs are date/time/location-stamped as well. Additional functionality may be provided to permit Audio Captions, Text Captions, and Comments to be stored and date/time/location-stamped on their own, without being associated with any photographs or other media items. In some embodiments, an interface is provided for the user to modify date/time/location stamping of media items, Audio Captions, Text Captions, and/or Comments, in the event a media item, Audio Caption, Text Caption, or Comment is stored or created significantly out of sequence or in a location not related to the intended location.

It should be understood that the assignment of Set Names, Subset Names, Comments, Audio Captions, Text Captions, Tags, Subtags, and other metadata, in embodiments of the disclosure, is desirably performed by the user using camera 100 as close to the time of media capture as possible. Accordingly, in various embodiments of the disclosure, users may select and assign such metadata using camera 100 before media capture, during media capture (e.g., using touchscreen controls while recording video or between taking photographs), or after media capture.

After each photograph (or other media item) is captured, in one embodiment, a unique filename may be created by concatenating Set Names and/or Subset Names, a number generated by a sequential number generator, Text Caption, and/or other metadata associated with the photograph. The unique filename is the filename used for storing the photograph on media storage devices 107 and/or any remote or networked storage devices via communication interfaces 115.

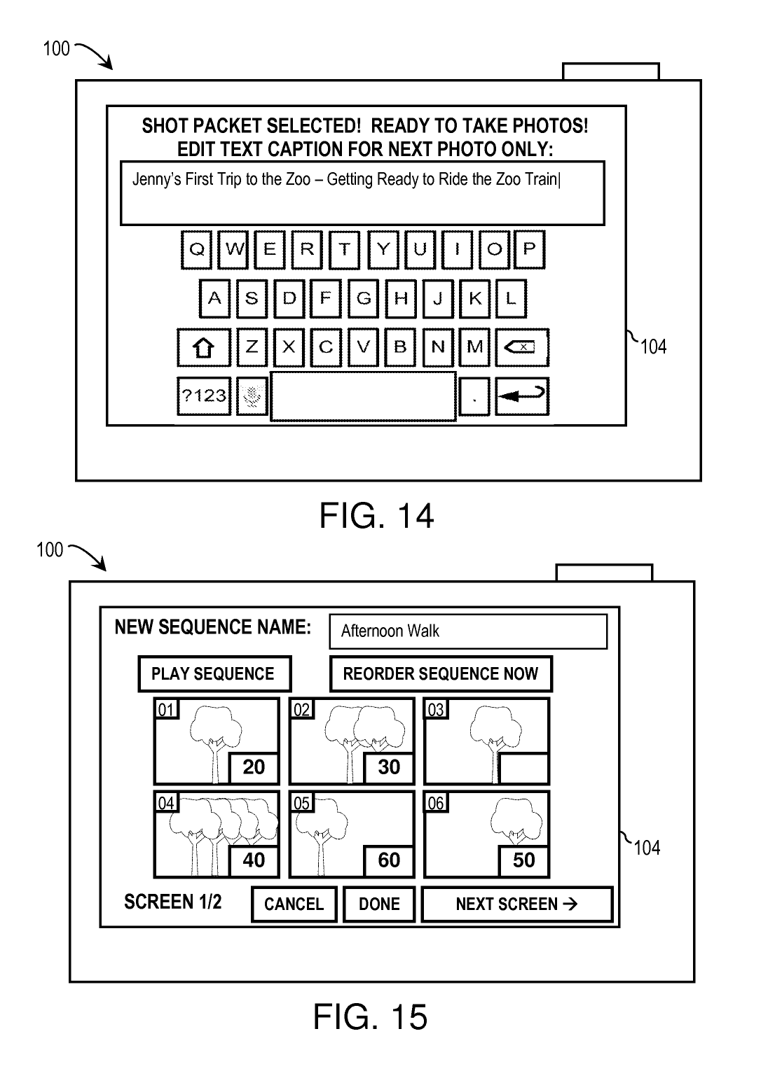

FIG. 11 shows an exemplary “shot packet” creation screen view, in one embodiment of the disclosure. A shot packet is a set or subset of photographs with or without Audio Captions, Text Captions, and/or video clips, the purpose of which may be to group or unify a subset or set according to a theme. To this end, in one embodiment, a shot packet has a Text Caption field that is used as a title displayed on a title screen, and the title might be used as (part of) a displayable caption for all shots included in the shot packet. In one embodiment, as shown, a button is provided for the user to indicate that the next photograph taken will be the first shot of a shot packet. Once that button has been selected, as shown in FIG. 12, the user is prompted to enter a Text Caption. In this embodiment, the Text Caption persists from the first shot of the packet to all subsequent shots until the user modifies the Text Caption to a different Text Caption or turns off the Text Caption feature, while, in other embodiments, Text Captions are individually entered for each shot captured. As shown in FIG. 13, in one embodiment, at all times during media capture, the current Text Caption for the shot packet are displayed, to ensure that the user intends for that Text Caption to be assigned to the current and subsequent photographs being that are taken. A “Customize Text Caption” button is provided to permit the user to make additions or changes to each subsequent shot's Text Caption field to customize individual titles displayed when the shot packet is later exhibited, in the event the user does not wish for the Text Caption of all photographs in the shot packet to be identical. When the user selects “Customize Text Caption,” the user is taken to the screen view shown in FIG. 14 to modify the shot packet Text Caption for only the subsequent photograph. Once the photograph has been taken, the Text Caption that persists from shot to shot is the unmodified Text Caption that was entered at the beginning of the entire shot packet (e.g., as shown in FIG. 12). In some embodiments, the Text Caption appears during a slideshow on the first media item of the shot packet, or may alternatively appear on or near all of the media items of the shot packet during presentation. In other embodiments, the Text Caption may appear during a slideshow as its own separate title graphic at the beginning and/or end of the display of the shot packet. In like manner to Text Captions, Audio Captions can be alternatively or additionally added to shot packets and/or modified on a per-shot basis. In some embodiments, multiple Audio Captions can be associated with a shot packet by having audio files associated with more than one shot in the packet. In some embodiments, the user is provided with an option to create a shot packet retroactively for a group of photographs (or other media) that has already been captured.

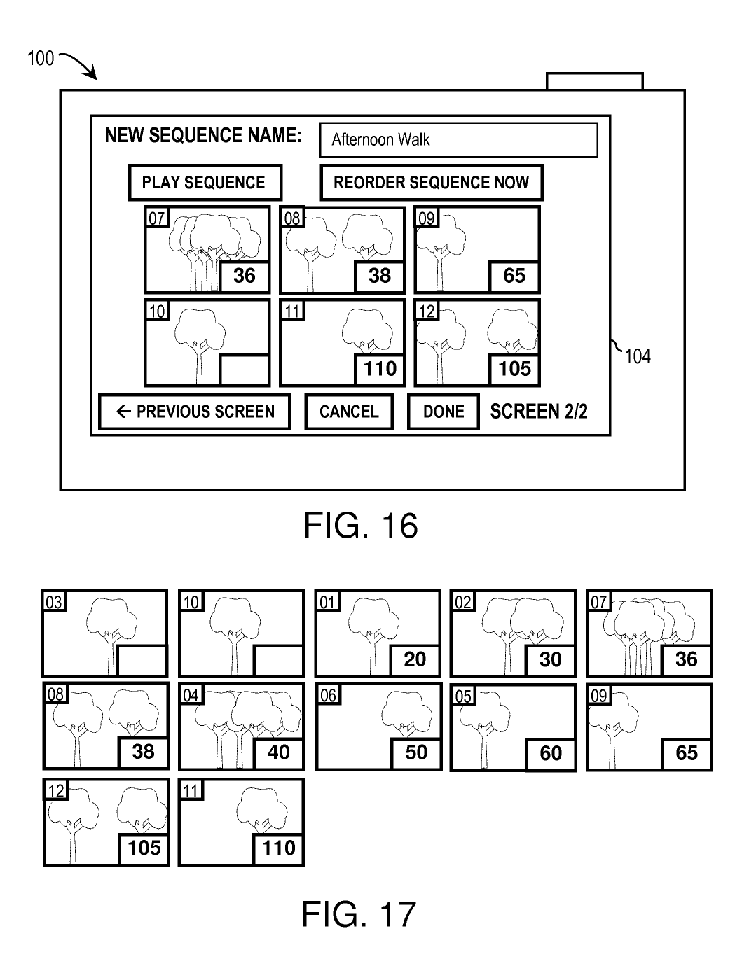

FIGS. 15 and 16 show exemplary Sequence creation/editing screen views, in one embodiment of the disclosure. While, conventionally, media items may be reordered within a sequence by drag-and-drop on a computer, such operations can be more difficult to perform given the small screen area for viewing and control on a digital camera, smartphone, or other mobile device. To make reordering simpler, the Sequence feature permits a user to assign sets of numbers to a group of photographs or other media items, e.g., for purposes of setting the order of exhibition. A particular photograph can have more than one associated Sequence Number. First, a Sequence Number is automatically generated and assigned as each photograph is taken, reflecting the order in which the photos were taken. All of those photographs can, but do not necessarily have to, belong to another grouping, such as a set, a subset, or a shot packet. As shown in FIGS. 15 and 16, the user can take an existing sequence of photographs and create a custom, user-created sequence. The user can assign a chosen Sequence Name and can reorder the photographs in the existing sequence as follows. In the example of FIGS. 15 and 16, there are 12 photos, which do not all fit on one user screen view, and so the user can page between the first six and last six photos using on-screen controls. In the top-left corner of each photograph, the automatically-generated Sequence Number for each photo is shown. The user can select an entry field at the bottom-right corner of each photograph to enter a new Sequence Number for that photograph. Sequence Numbers can be as large as the user wants (only as limited by memory), to permit insertion of photos wherever desired, e.g., the user can enter sequence numbers on orders of magnitude of 100s and 1000s, etc, even for only a handful of photographs. Sequence Numbers can also be smaller than 1 and can include decimal numbers, e.g., to permit adding a photograph with a Sequence Number 3.5 between Sequence Numbers 3 and 4. If the user does not enter a new Sequence Number for a given photograph, then the automatically-generated Sequence Number is kept for that photograph. The user can select “Play Sequence” at any time to view a slide show of the photographs in their newly-selected order. When the user has finished entering new Sequence Numbers, the user selects “Reorder Sequence Now,” and the photographs are reordered so that an automatically-generated Sequence Number for a photograph is replaced with any new Sequence Number entered by the user. FIG. 17 shows an exemplary order of photographs for a slide show from the example of FIGS. 15 and 16, after the photographs have been reordered according to the user-specified Sequence Numbers. In some embodiments, after this reordering has taken place, new automatically-generated sequential Sequence Numbers that replace the user-specified Sequence Numbers may be assigned to the new sequence to facilitate reordering. In some embodiments, automatically-generated Sequence Numbers increment by steps of 10, 100, or the like, to facilitate insertion of photographs between those Sequence Numbers. The amount of such increments, the starting Sequence Number, and the like, can be made user-selectable. A single photograph or other media item can belong to more than one sequence. In some embodiments, in addition to reordering, a user can remove photographs from a sequence altogether. In one embodiment, as soon as a user enters a new Sequence Number for a photograph, the entire sequence is instantly reordered on screen.

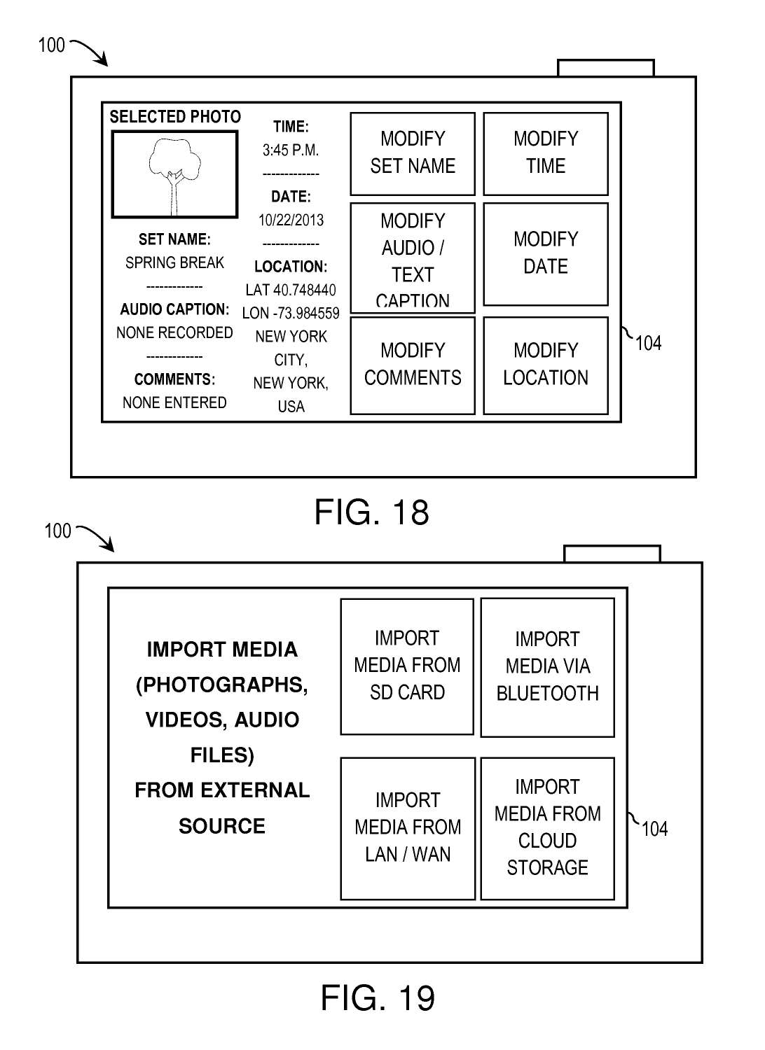

FIG. 18 shows an exemplary metadata modification screen view, in one embodiment of the disclosure. This feature permits a user to go back and modify metadata associated with already-captured photographs or other media items (e.g., to change incorrect information), or add missing or incomplete metadata. This feature may be selected, for example, immediately after a photograph has been taken (e.g., on a review screen display), by selecting a photograph from a list of photographs, or the like. Once a user has selected a photo whose metadata is to be modified, the user is presented with a screen view such as that shown in FIG. 18, including the selected photo and its current metadata (Set Name, Text Caption, Audio Caption, Comments, Time, Date, and Location), and selectable buttons that lead the user to input routines for modifying the corresponding metadata items. In one embodiment, a user can select more than one photograph or other media item at a time and modify the associated metadata for those selected photographs or other media items in a single operation.

FIG. 19 shows an exemplary media import screen view, in one embodiment of the disclosure. Using this feature permits a user to import from external sources, for storage into camera 100, photographs or other media items or files that were previously captured and stored using a different device, or that were previously stored using camera 100 and are now stored on removable media. This permits operations (such as metadata modification, for example) to be performed on those imported media items or files, just as if those items were media items that had been captured in the manner described above. As shown, once a user has selected an option to import media, the user is presented with a screen view such as that shown in FIG. 19, including buttons to select whether the media will be imported from a removable storage card, via a wireless network connection from a LAN/WAN-networked device, from a cloud-storage service, or via a Bluetooth connection. In some embodiments, metadata (e.g., Subset Names, Comments, Audio Captions, Text Captions, Tags, Subtags, Time, Date, Location, Sequence Numbers and Names, and so forth) is desirably imported along with media items themselves. Such metadata may be used to automatically group imported media with existing media in camera 100, e.g., to unify photographs that are stored on multiple physical storage devices that are all part of the same set and thus have the same Set Name. For imported media having insufficient associated user-generated metadata that can be used for such grouping, automatic suggestions for such grouping may be made by correlating metadata from the imported files that was automatically generated (e.g., Time, Date, and Location) with similar metadata from media files on camera 100. For example, an imported photograph having a date of Jan. 1, 2012 and a location of Washington, D.C. might automatically be assigned the set name “Trip to Washington” based on the existence of the set name “Trip to Washington” in a number of files stored in camera 100 bearing the same date of Jan. 1, 2012 and having similar (as may be determined, e.g., by fuzzy logic) GPS coordinates. The user may be presented with an option to accept or reject such automatic suggestions, in one embodiment, before those suggestions result in new metadata being added to the imported media. In one embodiment, for imported media items or files that already contain embedded or associated metadata (e.g., EXIF data of a JPEG-formatted image file), such metadata is copied to a separate database and unified with other metadata stored in the same format in which camera 100 stores metadata for media items captured by camera 100.

### Media Processing Module

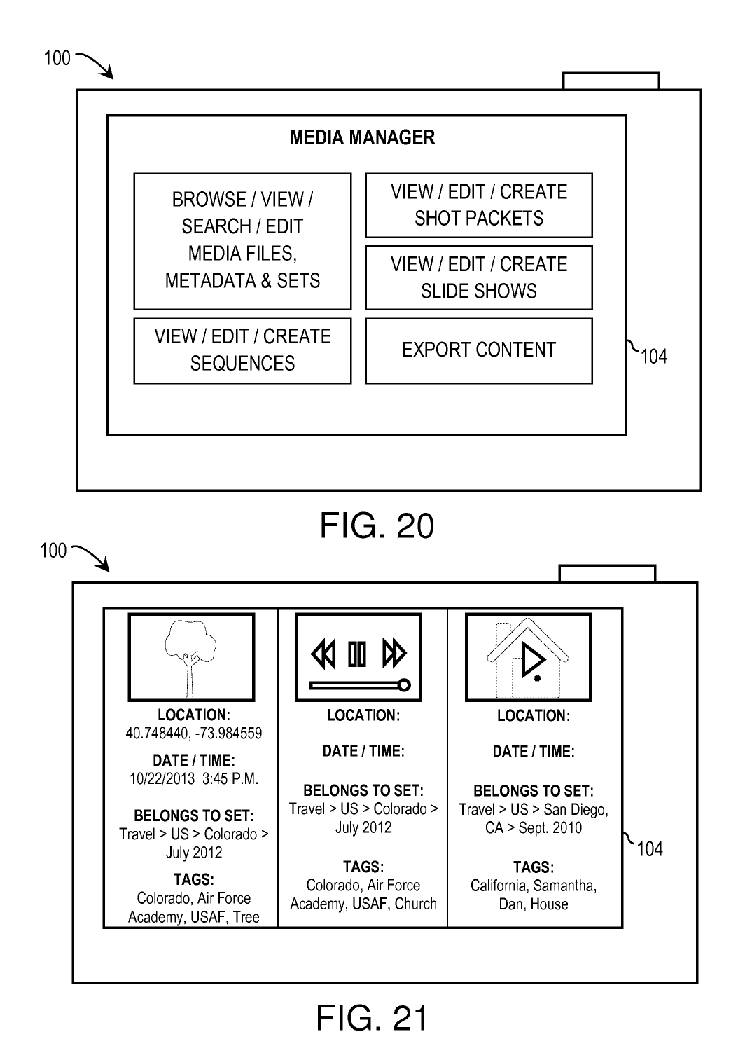

Exemplary modes of operation of media processing module 113, in one embodiment of the disclosure, will now be described with reference to FIGS. 20 and 21.

As discussed above, media processing module 113 is adapted to effect the appropriate functionality for processing media that has already been captured, including editing, labeling, organizing, arranging, and/or exhibiting media items in the form of a slideshow or other presentation. Detailed descriptions of basic functionality, such as editing photos (e.g., cropping, adjusting exposure, applying various creative effects to digital images, and the like) are not necessary for a complete understanding of this disclosure. However, to the extent media processing module 113 functions differently from conventional photo-editing software, such differences will be discussed below. It should also be appreciated by now that functionality of media capture module 112 and media processing module 113 are intertwined, and that features ascribed to one of these modules in this description (e.g., the Sequence creation/editing feature shown in FIGS. 15 and 16) could alternatively be implemented in the other module, in both modules, or in one or more altogether separate modules.

When the user selects a media processing option (which may be displayed, e.g., as an option in a menu of media capture module 112 or as a button during media capture), media processing module 113 executes, and the user is taken to a view such as that of FIG. 20, which shows an exemplary media processing module main menu screen view. From this menu, the user can choose from buttons that lead to the following further processing operations: browse/view/search/edit media files, metadata, and sets of media files; view/edit/create sequences; view/edit/create shot packets; view/edit/create slide shows; and export content.

If the user selects browse/view/search/edit media files, the user is presented with an interface that permits the user to browse existing media on camera 100, view individual media items or groups of media items, search media items using metadata, or edit selected media items. Other screen views (not shown) or interfaces may be used for functions that are generally known, such as searching media items by specifying metadata criteria such as tags, a Set Name, a date range, or the like.

In one embodiment, a view such as the screen view of FIG. 21 may be employed for the user to browse media items and change their associated metadata. In this example, the media items are of mixed types and include photographs, audio files, and video files. Using a “swipe” gesture to scroll left and right through files, the user can see a “thumbnail”-style graphical representation of each file, along with its associated metadata, including location, date, time, set membership, and tags. It is noted that, in this embodiment, the Set Name field is used for grouping (and not tagging), while the Tag Name field is used for tagging. The user can select a media file to change its associated metadata. For example, a user can input set membership and tag information by making selections from drop-down lists, menu trees (e.g., as shown in FIG. 4), group selections for adding or removing tags (e.g., as shown in FIG. 6), or the like, entering new text in a box using an on-screen keyboard overlay, or by speech recognition. In this embodiment, for each tag (i.e., Subtag Name) shown, its parent tags are all shown as well, while only the deepest level of Subset Name is shown as the “Set Name,” due to limitations of screen size on a mobile device. Date, time, and location are displayed only if that data was captured along with the media items. In the example of FIG. 21, at left is a still photo, in the middle is an audio recording, and at right is a video. The audio and video files include playback controls so that a user can listen to or view them to inspect their content prior to modifying their metadata. Set Name and Subset Name can be changed or can be removed altogether, i.e., reset to blank or null values.

During the display of media items while browsing and during the exhibition of sequences, shot packets, and slide shows, still images and moving video content is automatically played as it is encountered, and the best size for displaying the media item is automatically determined, given the image resolution, screen size, and viewing distance from the screen (with screen size and viewing distance desirably being settings that are adjustable by the user). In some embodiments, the method for display involves the use of computer processors in conjunction with high definition TVs, where a processor may be built into the TV or may be a separate module. In one embodiment, the only action needed to start the viewing of a set of media items, sequence, shot packet, or slide show, is the user clicking on the name of the respective set, sequence, shot packet, or slide show to display.

By selecting buttons to view/edit create sequences, view/edit/create shot packets, and view/edit/create slide shows, the user is presented with various interfaces (not shown) for performing these functions, which may be implemented in a number of ways. Sequences, shot packet, and slide shows all permit the user to form sets or sequences of media items, as described in further detail above, on a portable electronic device such as camera 100, a smartphone, or the like. Such sets or sequences may be manually-controlled sequences of individual media items or automatically-playing slideshows of media items, either of which might or might not be accompanied by audio. The media items can be still photographs or moving video (which could, for example, play automatically, from beginning to end, before the next media item is displayed), with or without sound, and with or without captioning, titling, or other additional visual elements. In different embodiments, text captions may be displayable, e.g., in a text box, scrolling vertically if the content overflows the box, or as a “crawl,” with one line scrolling horizontally, or as a full screen (scrolling) text box that fades in over a shot, stays visible for a time to be read, then fades out showing the media item again.

Although shot packets are described above as being created by pre-assigning a subsequent set of media items about to be captured to a set, media processing module 113 may permit creating shot packets, e.g., by browsing to select a plurality of media items, and then assigning the selected items to be a shot packet, retroactively.

In one embodiment, an automatic slideshow can be created that contains a combination of still photography, videography, audio as soundtrack, audio independent of video, and text captioning, using an algorithm that employs a particular rule structure, with or without further input or adjustment by the user. Such an algorithm makes decisions based on a quick, overall analysis of the body of the set's content using associated stored metadata, so that certain content (e.g., photos taken close together in time) is played together or contiguously. In one embodiment, any single edit by the user will have an effect on the overall playback by the algorithm. An automatic slideshow algorithm may execute according to a script or parameters provided by the user but employs machine-based rules to spread the display of related still photography out across segments of free audio, so that the visual duration ends up being the same as the duration of the of the audio clip. In one embodiment, some of the material for a slideshow may reside on one or more remote servers, in which event a caching process begins so that at least a portion of such material may be cached prior to the beginning of the exhibition of the slideshow.

During playback of a slideshow, shot packet, or sequence, user controls are provided for pausing and restarting the slideshow. While paused on a shot, the user can perform many functions, e.g., zooming and panning on a shot. In one embodiment, several contiguous shots are buffered concurrently to permit like shots to be compared quickly. The user can quickly advance or rewind shot-by-shot, or by a number of shots at a time, and the user can seek out particular shots by Sequence Number, Tag Name search, Set Name or Subset Name search, or from a display of graphic “thumbnails,” as shown, e.g., in FIG. 21. Resumption of automatic playback can be from the current shot, or from the shot at which the slideshow, shot packet, or sequence was originally paused.

While playback is paused, the user can also edit shots, including adding, editing (via various standard manipulations, such as cropping, density modification, and the like), or deleting (hiding) the actual visual content, with the rejected shot either deleted, moved to an out-take folder, or the metadata of the rejected shot modified (e.g., using a binary Outtake field) to indicate that the shot has been rejected. Likewise, Text Caption, Comment, tagging, and other such metadata-based information can be added, edited or deleted. Any errors in set or subset membership can be corrected. Recorded sound can be made to “loop” and then become an overall soundtrack for all or part of the slideshow, in addition to or instead of other recorded sound. In one embodiment, this is accomplished using a separate soundtrack whose sound is mixed with the main soundtrack. The recording used may be specially created for this purpose, or may be borrowed or copied from one of the shots originally captured. Additionally, the order of shot display can be changed, e.g., as described in further detail above with respect to FIGS. 15-17. Being able to edit while viewing shots in the form of a slideshow, shot packet, or sequence minimizes the time invested in creating a presentation.

If the user selects “Export Content,” then the user is provided with functionality for exporting data in the form of a slideshow, shot packet, or sequence, e.g., (i) to standard presentation software, such as PowerPoint, or (ii) to export an entire slideshow, shot packet, or sequence through conversion to one or more video or other multimedia formats. The exported data may be stored in camera 100 (e.g., on media storage devices 107) and/or provided to external computing devices via communications interface(s) 115.

### Task Encouragement Module

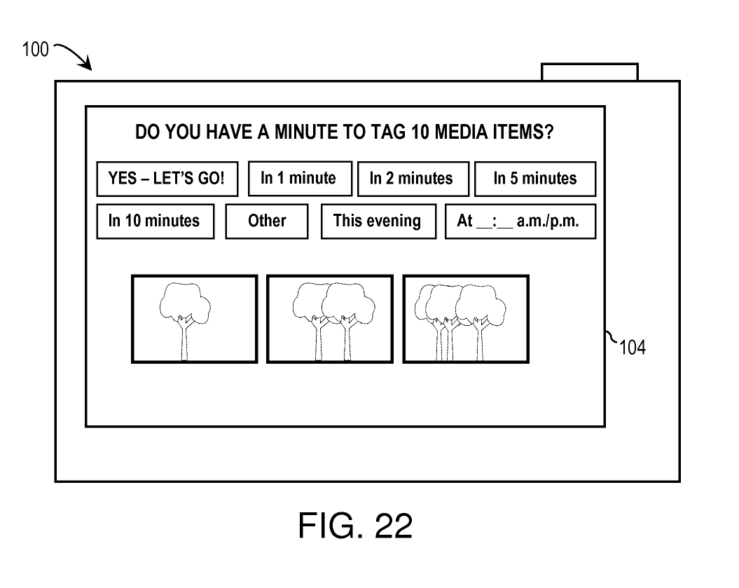

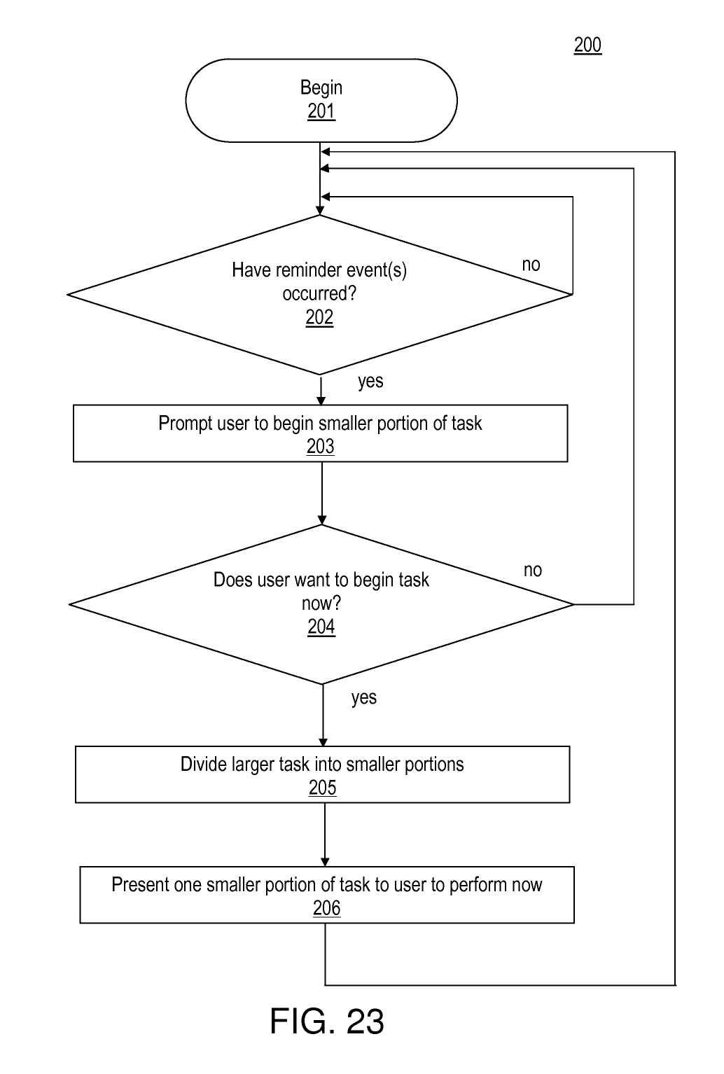

Exemplary modes of operation of task encouragement module 114, in one embodiment of the disclosure, will now be described with reference to FIGS. 22 and 23.

In one embodiment, task encouragement module 114 is implemented as a memory-resident module that continuously executes concurrently whenever camera 100 is on, or at least during the execution of either of media capture module 112 or media processing module 113. The purpose of task encouragement module 114 is to remind the user, at predetermined times or based on the occurrence of predetermined conditions, that there are media items in need of attention because they are missing one or more predetermined items of metadata, and to prompt the user to provide those items of metadata during brief sessions that involve the user working with only a few media items at time.

In one embodiment, task encouragement module 114 monitors the creation of “new” media files, e.g., unprocessed, uncharacterized, ungrouped, or unevaluated media files. The user can change a setting to define what constitutes a “new” media file, e.g., a file that has not yet been assigned one or more Tag Names, a file that has not yet been assigned one or more Set Names or Subset Names, or the like.

In one embodiment, when task encouragement module 114 initially executes, all media files are new (i.e., unprocessed), and it is not until significant use of task encouragement module 114 that most or all media files will have been processed, such that only newly created, or newly imported media files will be considered new.

In one embodiment, task encouragement module 114 monitors an internal clock (not shown) of camera 100, and, at one or more predetermined dates and/or times of day, a reminder event is triggered, i.e., the user will be prompted to begin a session of supplying missing metadata. In another embodiment, instead of a reminder event of task encouragement module 114 being triggered by date and/or time of day, a reminder event is triggered when the one or more processors 101 of camera 100 are determined to be idle or low in usage, or when the user is detected to be idle or not very busy (e.g., not actively taking pictures or otherwise using camera 100 for significant activities). Other events may be used in alternative embodiments, including a reminder event of task encouragement module 114 being triggered when a threshold number of media items that are missing metadata have been stored in camera 100, or the like.

When a reminder event of task encouragement module 114 is triggered, a modal window (i.e., a window overlaying the window currently being viewed, or last viewed if the device is currently off) is displayed to the user, such as that shown in FIG. 22. In some embodiments, the user may select a setting to choose whether to be disturbed with reminder events while camera 100 is off by having task encouragement module 114 turn camera 100 on, or whether to wait until the next time the user powers on camera 100. Since the reminder event is not typically time-critical, if camera 100 is already powered on, then task encouragement module 114 waits until the user is finished with his or her current activity (e.g., typing using an on-screen keyboard, recording audio, etc.) before making the reminder event known to the user.

As shown in FIG. 22, in one embodiment, the reminder event involves the sudden appearance of a modal window, which may be accompanied by an audible and/or tactile (e.g., vibratory) alert to the user. In this embodiment, the reminder event is for media items that have no associated tags. The modal window prompts the user “Do you have a minute to tag 10 media items?” and waits for the user to select either “Yes—Let's Go!” or “In 1 minute,” “In 2 minutes, “In 5 minutes,” “In 10 minutes,” “Other” (which prompts the user to enter a custom number of minutes, days, or other time period, after which the reminder event will return), “This evening” (which delays the reminder until a predetermined time later in the evening, or “At ______:______a.m./p.m.,” (which prompts the user to enter a specific time for the reminder event to return).

At the bottom of the modal window is a display of some of the 10 media items that need tags, and these media items may be scrollable by the user to permit viewing of all 10 media items, or might scroll automatically, in some embodiments. In other embodiments, the media might appear one at a time, or all 10 media items could all appear together in a reduced size. Such options and other style options may be user-selectable settings.

It should be understood that, in this example, there are more than 10 media items that need tags, and perhaps even hundreds of untagged items in need of the user's attention. However, in order to make the task of tagging more convenient and less obtrusive and burdensome to the user, as well as increasing the chances that the user will actually perform that task, task encouragement module 114 has the ability to break that larger task of tagging a large number of media items into the more-palatable smaller tasks of tagging only 10 media items at a time, at times when the user is likely to be able to take a minute and easily complete a small portion of the much larger task.

If the user selects “Yes—Let's Go!” then the user is taken to views similar to the screen views of FIGS. 6, 7, and 21, where the user can select tags for the 10 media items. This process may occur in media processing module 113 or a less resource-intensive software module that contains only the functionality used for supplying the missing metadata (without media-editing or media-exhibiting functionality), which may be integrated into task encouragement module 114.

When the user has completed tagging the 10 media items, task encouragement module 114 closes the modal window and returns the user to his or her previous state. In alternative embodiments, other steps may take place prior to the user being returned to his or her previous state. For example, after the user has finished tagging the 10 media items, the user might be presented with a prompt for camera 100 to determine whether the user wishes to continue the task beyond the small portion already performed, such as “Keep tagging! Do you want to tag another 10 media items now?” Alternatively or additionally, after the user has finished tagging the 10 media items, the user might be presented with a “See what I just tagged!” button or similar on-screen control that, when activated, provides the user with positive feedback to encourage the user to continue tagging, such as by presenting a slideshow of the 10 tagged media items, with an overlay of the newly-added tags. Other types of positive feedback might be provided to the user in other embodiments.

In one embodiment, any postponement time selected or entered is coordinated, through a server database or other method, such that the user is not issued reminder events at intervals too close together by multiple devices that the user employs, which all execute respective task encouragement modules 114.

User-selectable settings may be provided to control various features, e.g., specific windows of time during which task encouragement module 114 is permitted to issue a reminder event to the user, the number of media items at a time that are presented to the user to work on at each reminder event, custom notification sounds and/or tactile (e.g., vibratory) alerts, or disabling reminder events completely. Attempting to disable reminder events completely prompts the user with an “Are you sure?” response and lists any ramifications of disabling the reminder events, prior to receiving confirmation from the user.

In one embodiment, task encouragement module 114 has the ability to detect all existing types of media items, including photos, videos and audio files, anywhere on the device it is operating on, as well as on any storage devices that are connected to camera 100 via one or more of communications interfaces 115. In some embodiments, task encouragement module 114 accesses cloud storage via the Internet, connects to accounts owned by the user, and locates media files therein that are missing metadata, and handles supplying metadata to those media files in the manner described above.

Although task encouragement module 114 is described above with specific reference to supplying missing metadata for media files in the context of camera 100, it should be understood that a task encouragement module consistent with alternative embodiments of the disclosure is useful in many other applications as well.

A task encouragement module consistent with embodiments of the disclosure “divides” a task into a plurality of portions, each of which is smaller than the whole task. The specific process of dividing a task will vary, depending on the task itself, and may be performed in a number of ways, in different embodiments of the disclosure. For example, in the case of tagging, labeling, assigning Set Names or Subset Names to, or performing other operations on a number of media items, as described above, the step of dividing the task into a plurality of portions includes counting the media items that the task involves and dividing the number of media items into smaller sets of media items, where performing the task for one of the smaller sets constitutes performing a divided portion of the task. As another example, in the case of sorting, cleaning, organizing, or performing other operations on a number of email messages, the step of dividing the task into a plurality of portions includes counting the email messages that the task involves and dividing the number of email messages into smaller sets of email messages, where performing the task for one of the smaller sets constitutes performing a divided portion of the task. For tasks that do not involve items that can be counted, such as media items or email messages, the step of dividing can involve other types of division. For example, in some embodiments, a task may be divided into portions based on the amount of actual, projected, or estimated time that the task will take to perform. In such embodiments, the task encouragement module may serve the smaller portion of the task to the user in a session by providing a time-limited window for the user to perform the task. When the time limit ends (e.g., as may be indicated by a running time clock displayed to the user), the session ends, and the user may be prompted for confirmation, to save his or her work, or the like, prior to the session actually closing and the user being returned to his or her previous state.

In other embodiments, a task may be divided into portions based on other criteria, such as computing resources consumed by the task (e.g., storage used, memory used, CPU used).

It is not necessary that the divided portions of the task be equal portions, or even substantially equal portions. In some embodiments, it may be desirable for the task to be divided in portions that are unequal. For example, a user might wish to perform larger portions of the task on weekends while the user is home and smaller portions of the task during the workweek, when the user has less time. Accordingly, in some embodiments, the user may specify such unequal divisions, for example, that the user wishes to tag 20 media items at a time on Saturdays and Sundays and only 10 media items a time Monday through Friday. In other embodiments, the task encouragement module might determine that unequal divisions are advantageous for some reason and make unequal divisions, as might be further restrictable by user settings. Thus, in some embodiments, a task may be divided into portions based on criteria not specific to the task itself, but specific to the user, as may be indicated by user-specified preferences, or the like.

Although embodiments of the disclosure encourage a user to perform a portion of a task, and desirably to perform the entire task as a whole, it should be understood that, in a task encouragement module consistent with embodiments of the disclosure, it is not necessary that all of the portions of the task, or that any of the portions of the task, actually be performed by the user.

A task encouragement module consistent with embodiments of the disclosure can be implemented in a smartphone or other mobile device, in a laptop or desktop computer, or in any other computing device that allows a larger task to be presented to a user in smaller, divided portions, based on the occurrence of predetermined conditions or at predetermined intervals.

In alternative embodiments, a task encouragement module consistent with the disclosure may be implemented using multiple devices in communication with one another, such as a web server in communication with a mobile device or user workstation. In this scenario, the task encouragement module, which may be implemented on an Internet server, monitors for the particular occurrence of one or more events, either alone or in combination, e.g., time interval(s) passed, date(s)/time(s) of day, idle CPU, idle user, particular files that need the user's attention (e.g., untagged media files, unread junk email messages, unverified address book contacts, etc.), and so forth. Upon the detection of the one or more events, the task encouragement module sends an email, SMS message, or other communication to the user, e.g., via the Internet or a telephonic network, or the task encouragement module may generate a modal window, such as that shown in FIG. 22, on a display of the user's local device. The email, SMS message, or other communication desirably contains a link to the web server (or another remote server) that the user can follow to begin a web-browser session, where the user is presented with a smaller, divided portion of the larger task to perform via application service provider (ASP) software provided by the web server (or another remote server). Alternatively, a remote task encouragement module might monitor for the particular occurrence of one or more events, then send an email or SMS message to the user, and then have the user complete the task either solely as a local task on the user's local device or as another kind of remote task that does not necessarily involve employing the user's web browser, employing a link to a server, and/or employing ASP software executing on the web server or another server.

The following non-limiting examples describe several various implementations of task encouragement modules, consistent with embodiments of the disclosure.

As a first example, in one embodiment, a task encouragement module is implemented as a memory-resident software process on a laptop computer and is used to remind the user, when the CPU is detected to be idle, that the user has a large number of untagged media items on his or her laptop computer, prompting the user to tag those items in smaller batches (e.g., 10 media items at a time).

As a second example, in another embodiment, a task encouragement module is implemented as a memory-resident software process on a laptop computer and is used to remind the user, when the CPU is detected to be idle, that the user has a large number of unread email messages in the inbox of the mail client of his or her laptop computer, prompting the user to review those messages in smaller batches to save or delete them (e.g., 25 email messages at a time).

As a third example, in another embodiment, a task encouragement module is implemented as a memory-resident software process on a smartphone and is used to remind the user, at 6:30 pm Mondays through Fridays while the user is usually riding the train, that the user has a large number of unread email messages in the inbox of a remote Microsoft Exchange mail server, prompting the user to review those messages in smaller batches to save or delete them (e.g., 25 email messages at a time).

As a fourth example, in another embodiment, a task encouragement module is implemented as a memory-resident software process on a smartphone and is used to remind the user, when the user does not appear to be using the smartphone and battery power is not running low, that the user has a large number of unread email messages in the junk mail folder of a remote Microsoft Exchange mail server, prompting the user to review those messages in smaller batches to save or delete them (e.g., 25 email messages at a time).

As a fifth example, in another embodiment, a task encouragement module is implemented as a memory-resident software process on a smartphone and is used to remind the user, on Tuesdays between 3:00 pm and 5:00 pm only if the CPU is detected to be low, that the user has contacts in his or her email or phone address book for whom no photos currently are assigned, prompting the user to review those contacts in smaller batches to add photos to those contacts (e.g., 5 contacts at a time).

As a sixth example, in another embodiment, a task encouragement module is implemented as a memory-resident software process on a desktop computer and is used to remind the user, every day at noon, that there are contacts in his or her email or phone address book that need to be verified, prompting the user to review those contacts in smaller batches to verify the information stored for those contacts (e.g., 5 contacts at a time).

As a seventh example, in another embodiment, a task encouragement module is implemented on a mail server adapted to send an SMS message to the user's mobile phone or an email to the user, once a week, whenever the user has a large number of unread email messages in the junk mail folder of the mail server. The SMS or email message contains a clickable link that takes the user to a web page where the user can instantly review those messages in smaller batches to save or delete them (e.g., 25 email messages at a time).

As an eighth example, in another embodiment, a task encouragement module is implemented on a cloud storage server adapted to send an SMS message to the user's mobile phone or an email to the user, once a week, whenever the user has untagged media items residing on the cloud server. The SMS or email message contains a clickable link that takes the user to a web page where the user can instantly review and tag those media items in smaller batches (e.g., 10 media items at a time).

As a ninth example, in another embodiment, a task encouragement module is implemented as part of an email client software application that the user installs on his or her laptop computer, whereby the task encouragement module executes only while the email client software is also executing. The email client software application uses the task encouragement module to remind the user, at 10:00 am daily, only while the email client software application is running, that the user has a large number of unread email messages on the user's locally-stored inbox of the email client software application, prompting the user to review those messages in smaller batches to save or delete them (e.g., 25 email messages at a time).

As a tenth example, in another embodiment, a task encouragement module is implemented as part of a tax-preparation software application that the user installs on his or her desktop computer, whereby the task encouragement module resides on a remote server, is activated when the user installs the software, and is adapted to send multiple reminders concurrently, including an SMS message to the user's mobile phone, an email to the user, and the display of an on-screen reminder on the user's desktop computer via a modal window, to remind the user, at 7:30 pm daily, that the user has not finished completing his or her itemized deductions on Schedule A of Form 1040 of the U.S. Internal Revenue Service, and to let the user know how many days remain before the deadline by which that form must be filed with the government. The SMS or email message contains a clickable link that takes the user to a web page for completing a smaller portion of the itemized deduction form (e.g., via a smartphone, tablet, laptop, or remote computer), in the event the user is not at his or her desktop computer. If the user is at his or her desktop computer, then the user can respond to a prompt in the modal window to be taken directly to the software to complete a smaller portion of the itemized deduction form. Since the task encouragement module does not know how many line items the user will have and is therefore unable to divide the task by dividing the number of line items that the user will be handling, in this embodiment, the task encouragement module divides the task by time, based, e.g., on the amount of time that it took for the user to complete the form the previous year, or the amount of time that the average user takes to complete the form, for example, 120 minutes. The task encouragement module divides that amount of time by the number of projected reminder events (i.e., for the user to complete smaller portions of the itemized deduction form) that will occur between the current date and the deadline by which that form must be filed with the government (120 minutes divided by four scheduled weekly reminders between now and the due date of April 15), resulting in a projected session length (of 30 minutes in this example), and the user is prompted with a message to spend that projected session length in a session completing a smaller portion of the itemized deduction form. Alternatively, the session length may simply be a predetermined, preset, or arbitrary time period, such as 10 minutes, which will be used as the incremental repeated period for completing the task, without calculating or computing such the session length.

A task encouragement module consistent with embodiments of the disclosure can also be used to assist in the performance of other tasks, including repetitive or lengthy tasks performed by users on social media sites, such as Twitter, Facebook, and the like, or other web sites, and may be implemented, e.g., using APIs of those social media sites or web sites.

FIG. 23 shows a flowchart for an exemplary method 200 performed by a task encouragement module consistent with one embodiment of the disclosure. As shown, the method begins at step 201. At step 202, a determination is made whether one or more reminder events have occurred, such as by monitoring for one or more of: time interval(s) passed, date(s)/time(s) of day, idle CPU, idle user, particular files that need the user's attention (e.g., untagged media files, unread junk email messages, unverified address book contacts, etc.), and so forth. If, at step 202, it is determined that no reminder events have occurred, then the method returns to step 202, and step 202 repeats until the reminder event criteria have been satisfied. If, at step 202, it is determined that the one or more reminder event criteria have occurred, then the method proceeds to step 203. At step 203, the user is prompted with a message to ask whether the user wishes to begin performing a smaller portion of a larger task. At step 204, user input is received to determine whether the user wishes to begin performing a smaller portion of a larger task. If, at step 204, it is determined that the user does not wish to begin performing a smaller portion of a larger task, then the method returns to step 202. If, at step 204, it is determined that the user does wish to begin performing a smaller portion of a larger task, then the method continues to step 205. At step 205, the larger task is divided into smaller portions. At step 206, one smaller portion of the larger task is presented to the user to perform. The method then returns to step 202.

It will be appreciated that countless applications for a task encouragement module consistent with embodiments of the disclosure are possible, other than those specifically described herein.

By using a server consistent with embodiments of the disclosure, users who have created content on a sharable service where a group of shots can be specified (such as a set of images in Filch) can have that group of shots exhibited along with the user's content. Moreover, media items and their metadata, which includes text descriptions and tags, can be stored on a passive server using an export function, as described above. In one embodiment, such text data and possibly all metadata will be in JSON or XML format. Using this arrangement, camera 100 is adapted to merge media items from two different sources, irrespective of whether those media items are in the same format or different formats.

In some embodiments, camera 100 is also adapted to merge two or more different slideshows, shot packets, sequences, sets, subsets, or other groupings of media items described herein, irrespective of whether those groupings are in the same format or different formats. It also does not matter whether the media items or groupings were created using camera 100 or using a different camera substantially similar or identical to camera 100, nor whether those media items or groupings were created by the same user or different users. To effect the merge, camera 100 employs the metadata corresponding to the respective media items (or, for merging groupings, the media items in the respective groupings), and correlates that data to harmonize the media items into a single arranged set or grouping. For example, a date-ordered slideshow created by one user using camera 100 can be merged with a different date-ordered slideshow created by a different user using a different camera substantially similar or identical to camera 100 to create a single slideshow. The resulting merged slideshow might be sorted by date, for example, such that slides from the two slideshows are interleaved with one another, resulting in a single merged slideshow containing all of the slides from both slideshows in date order. Multiple criteria and rules can be established for sorting and merging media items, slideshows, shot packets, sequences, sets, subsets, or other groupings of media.

In one embodiment, the user importing the data for merging media items or groupings of media specifies a Set Name with which the import is to be associated, and then the user specifies an order of precedence for correlating the media from two or more sources, e.g., whether geographical location or date/time takes precedence. In the case of media labeled and exported by such an embodiment (or at least accompanied by a formatted JSON or XML file), one or more Tag Names and Subset Names can be added to the ordered list of fields by which to sort the aggregated media files for the merge operation. In some embodiments, the sort for the low-order fields takes place first, with the high-order field sorting taking place last. In some embodiments, only media metadata is actually sorted and merged, and not media items themselves.

Various methods may be used for merging media into group efforts for purposes of collaboration among multiple users, for example, using Set Name as a grouping concept.

Thus, in one embodiment, contributors of media items create their own sets with all corresponding metadata supplied by each contributor for his or her own media captures, but the contributors agree to use the same Set Name, and possibly Subset Names, and even possibly tagging data. Next, a “workgroup” share functionality is used to move the subset of the user's database related to the shared set, to a target group member, e.g., in the JSON data format. The destination may be a folder on a server such as DropBox or an email address with a file as an attachment, which file is imported by the recipient's software. The media itself may also be moved, although, if the media is available on a server, then camera 100 can play it from its original location. Then, on playback, the methodology for merging described above would be used to determine the exact technique of playback.

In another embodiment, the method is more communal or “family-based.” Media files are shared and merged on each user's preferred data storage location. Then, users add their metadata to the media items. Then, the metadata is transferred to the group leader in the JSON format for the set with a common Set Name that each member has used. Then, the group leader's software physically merges the metadata and keeps it associated with the media items with which it was originally associated. Finally, a copy of the combined database segment associated with the set is disseminated to the group members, but only with their original media locations. Each member is then able to search and view the set in the same way they originally did, with the metadata of everyone in the group attached.

Although not specifically shown in the figures, in some embodiments, a “settings” screen view may be provided for modifying features such as the following exemplary features: (i) which set of content will be displayed on power-up, e.g., a default set, or the last set accessed; (ii) speed of slideshow; (iii) viewing distance from screen; (iv) screen size; and (v) selection of transition styles, a background pattern, and a picture-frame style for each set. In the case of background patterns, animation, video, and some combination of animation and video can be used to create more visually-appealing options than static patterns. System settings may also include selection of country and/or language.

One or more “listing” screen views may also be provided, from which all of the sets available for exhibiting can be selected by a user, e.g., using checkboxes to permit more than one set to be shown at a time.

In some embodiments, location and photo metadata may be used to automatically identify and download captured media items (e.g., photographs in JPEG format) from anywhere on the web.

In some embodiments, photos are automatically displayed with their text captions and/or their Audio Captions, if available.

In some embodiments, during a slideshow presentation, if there is an audio caption that is longer in duration than the settings-specified slideshow display time, then the photo will stay on screen long enough for the audio clip to finish.

In some embodiments, for shot packets, in manual-selection mode, selecting the packet starts a mini-slideshow of the shots in the packet. The way in which audio files attached to shots in the packet are played back is user-specifiable. If the entire set is being shown in slideshow mode, then playback is the same as when the packet is manually selected, except that the packet playback is initiated automatically after the previous shot has finished displaying.

In some embodiments, a shot displayed in the screen can be automatically resized based on screen size, resolution of the shot, and viewing distance from the screen.

Embodiments of the disclosure may be used for targeted advertising. The user's collection of photos and videos locates him or her at a particular place at a particular time in the past. The current location of the user can be determined, e.g., using a camera's or smartphone's GPS or tower-triangulation functionality. With the user's permission to access that location data, one or more algorithms may be employed to provide niche advertising for travel and related services, or other types of advertising. For example, in embodiments of the disclosure, automatic recommendations, suggestions, or advertisements may be provided for destinations that might be of a similar nature to a place previously visited (but not in the user's database of locations previously visited), or possibly services available near the user's current location, especially if the current location is not the user's home location. If location data is not available, similar results may be achieved using the date and time of the captures, and the name of the location for the date/time period that was supplied by the user. Advertising can range from embedded links to a single web page to a slideshow to a promotional video. The user may be given the option to escape out of any lengthy material, in some embodiments. Such advertising can link to a purchase opportunity. For targeting purposes, Set Names, Tag Names, and words in Text Captions and/or Comments may also be used as inputs to the algorithms. Multiple options exist for determining where and when links to ads appear. The user may be provided with options to select preferences for viewing ads, e.g., small links, always visible, along the border of the screen versus the occasional full-screen link, etc. In one embodiment, in exchange for free software and services, the viewer selects a list of advertising categories whose ads the viewer is willing to see. These choices may be changed over time, with a minimum number of categories that the user might be required to select in order to continue to use the free software.

Embodiments of the disclosure may be used for travel planning. In one embodiment, a “channel” is used to push video ads for particular destinations. The viewer enters prospective destinations and/or answers a set of questions (either yes/no or more open-ended questions), the answers to which direct the viewer to advertisements for particular locations. The answers are named as a profile and saved, and the user can change some answers and be offered new possibilities. Groups of answers are named and saved for later review of the results. Consumer profiles for the user are built up over time. In one embodiment, the user is asked to rate locations visited and to mark the reason for the rating, for the purpose of filtering future results. The system may be configured to provide a reminder before slideshows (and/or after each set is played) to check out the travel planner, e.g., by pressing a certain key.

As has been described above, shots (i.e., photos and videos) and other media and metadata may be stored on an existing, independently-operated, generic, multi-purpose, passive server service, such as Dropbox, in some embodiments of the disclosure. In this scenario, shots are stored in sub-folders named with the Set Names, and no web pages are served to the end user. Rather, exhibiting screens are created by native applications that download the shot files from their respective servers. Shots are available to the user for bulk copying and any other desired uses, without any coding or programming.

In one embodiment, a server system consistent with the disclosure is dedicated to, and operates in conformity with one or more of the functions described above. In another embodiment, the server serves web pages to be rendered in browsers, which provide the functions described above through the use of browser-based programming and functionality, without the use of any native applications.

In some embodiments, photo- or video-dedicated sites may be used for storage, wherein the only access to those sites is provided through the application programming interface (API) of the site. Alternatively or additionally, “home” storage on devices local to the user may be used for storage, including, e.g., hard drives and non-volatile solid-state storage, e.g., for archiving purposes.

In the case of a passive server system, access to the server is controlled by a small, portable database such as SQLite. In the case of a webpage-serving server, a true relational database, located on the server, can be used to help provide the functionality described above.

It should be understood that the use of the word “field” in the foregoing description does not limit embodiments of the disclosure to the use of relational databases, and non-relational databases may additionally or alternatively be used for storing media items and associated metadata, in embodiments of the disclosure.

It should further be understood that, although camera 100 is described herein as being a mobile device, such as a digital camera or smartphone, in embodiments of the disclosure, part or all of camera 100, including media capture module 112, media processing module 113, and task encouragement module 114, may alternatively be implemented in a laptop or desktop computer or other computing device.

Although the term “file” is used herein for convenience to refer to a media item, e.g., a photograph, video, or audio file, it should be understood that, in alternative embodiments, the disclosure is not limited to audio and/or visual data stored as individual files or using any particular type of file system, and that the teachings herein are also applicable to media items stored other than as individual files, such as a plurality of media items (e.g., still images) stored together in a single file along with metadata, in a proprietary format within a file system, or a single media item (e.g., a still image) that is stored in parts, across multiple files in a file system. Accordingly, the terms “item” and “media item,” as used herein, should be understood to include not only “media files,” but also other groupings of data corresponding to media capture events (e.g., still images, moving video recordings, audio recordings, and/or combinations of the foregoing), even if those groupings are not necessarily stored in a conventional manner or as ordinary files in a conventional file system.

The term “metadata,” as used herein, should be construed broadly as including all types of data providing information about one or more aspects of one or more media items, and should not be limited by any of the examples of data types, structures, and/or fields described herein with respect to any specific embodiments of the disclosure.

It should be understood that, in some embodiments, the display of one or more media items and/or slideshows, shot packets, sequences, sets, subsets, or other groupings of media items described herein may be effected using caching processes, irrespective of whether such items reside locally on camera 100, on a remote server, or on another device external to camera 100.

Thus, the foregoing disclosure provides services, software applications, websites, systems, and methods for creating virtual photo and video albums from actual shots (i.e., photos and videos) that may be located on multiple web sites or services, as well as for tying additional descriptive text and/or audio to individual shots, including a number of additional features in various embodiments of the disclosure. Such features may include, e.g.: the naming of sets of shots in a camera application prior to shooting; the specification of “shot packets” within a set; being able to group shots from diverse sources across the web into a virtual set; using Sequence Numbers to create and specify the order of various different subsets of shots, rather than having to physically move the shots using a method such as drag-and-drop; creating unusual graphic, animated and/or video background wallpaper over which shots are exhibited, as well as picture and video frames of varied graphic patterns; combining the editing and exhibition processes; providing an automated process in which algorithms assemble available photos, video and audio on the fly; and providing a task encouragement scheme for breaking down a larger task into smaller portions that are more easily performed by a user, and prompting the user to perform those smaller portions of the task in an unobtrusive manner.

### ALTERNATIVE EMBODIMENTS

It should be understood that the foregoing describes certain exemplary embodiments of the present disclosure, and that other implementations are possible.

It should be understood that different embodiments of the disclosure may be adaptable for different and specialized purposes. Embodiments of the disclosure may include implementation of a system on one or more shared servers or in one or more hardened appliances and may be part of a larger platform that incorporates media organization and/or task encouragement functionality as merely certain aspects of the platform.

It should also be understood that software and/or hardware consistent with embodiments of the disclosure can be employed, e.g., at endpoint nodes of a network, centrally within a network, as part of a network node, between a standalone pair of interconnected devices not networked to other devices, at a user's end, at the server end, or at any other location within a scheme of interconnected devices.

It should be understood that appropriate hardware, software, or a combination of both hardware and software is provided to effect the processing described above, in the various embodiments of the disclosure. It should further be recognized that a particular embodiment might support one or more of the modes of operation described herein, but not necessarily all of these modes of operation.

It should be understood that various changes in the details, materials, and arrangements of the parts which have been described and illustrated in order to explain the nature of embodiments of the disclosure may be made by those skilled in the art without departing from the scope of the disclosure. For example, it should be understood that the inventive concepts of embodiments of the disclosure may be applied not only in a capture device or system for organizing media items, but also in other applications for which embodiments of the disclosure may have utility, including, for example, other types of content-generation scenarios and other types of scenarios wherein encouragement to perform tasks by providing reminders and dividing tasks into multiple smaller components is desirable.

Embodiments of the present disclosure can take the form of methods and apparatuses for practicing those methods. Such embodiments can also take the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the disclosure. Embodiments of the disclosure can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the disclosure. When implemented on a general-purpose processor, the program code segments combine with the processor to provide a unique device that operates analogously to specific logic circuits.

It will be appreciated by those skilled in the art that although the functional components of the exemplary embodiments of the system described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present disclosure. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the disclosure as described herein may be implemented in one or more computers residing on a network transaction server system, and input/output access to embodiments of the disclosure may include appropriate hardware and software (e.g., personal and/or mainframe computers provisioned with Internet wide area network communications hardware and software (e.g., CQI-based, FTP, Netscape Navigator, Mozilla Firefox™, Microsoft Internet Explorer, Google Chrome™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the disclosure, in real-time and/or batch-type transactions. Likewise, a system consistent with the present disclosure may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, Google Chrome™, or Apple Safari™). Thus, embodiments of the present disclosure may be appropriately adapted to include such communication functionality and Internet browsing ability. Additionally, those skilled in the art will recognize that the various components of the server system of the present disclosure may be remote from one another, and may further include appropriate communications hardware/software and/or LAN/WAN hardware and/or software to accomplish the functionality herein described.

Each of the functional components of embodiments of the present disclosure may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the disclosure may be server-based and may reside on hardware supporting an operating system such as Microsoft Windows NT/2000™ or UNIX.

Components of a system consistent with embodiments of the disclosure may include mobile and non-mobile devices. Mobile devices that may be employed in embodiments of the present disclosure include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iPhone operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the disclosure include 2.5G cellular network technologies such as GPRS and EDGE, as well as 3G technologies such as CDMA1xRTT and WCDMA2000, 4G technologies, and the like. Although mobile devices may be used in embodiments of the disclosure, non-mobile communications devices are also contemplated by embodiments of the disclosure, including personal computers, Internet appliances, set-top boxes, landline telephones, etc. Clients may also include a PC that supports Apple Macintosh™, Microsoft Windows 95/98/NT/ME/CE/2000/XP/Vista/7/8™, a UNIX Motif workstation platform, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to embodiments of the present disclosure. These personal computers may run the Unix, Microsoft Windows NT/2000™ or Windows 95/98/NT/ME/CE/2000/XP/Vista/7/8™ operating systems. The aforesaid functional components of a system according to the disclosure may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to embodiments of the present disclosure may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present disclosure to achieve additional functionality.

In one embodiment, source code may be written in an object-oriented programming language using relational databases. Such an embodiment may include the use of programming languages such as C++ and toolsets such as Microsoft's .Net™ framework. Other programming languages that may be used in constructing a system according to embodiments of the present disclosure include Java, HTML, Perl, UNIX shell scripting, assembly language, Fortran, Pascal, Visual Basic, and QuickBasic. Those skilled in the art will recognize that embodiments of the present disclosure may be implemented in hardware, software, or a combination of hardware and software.

Accordingly, the terms “server,” “computer,” and “system,” as used herein, should be understood to mean a combination of hardware and software components including at least one machine having a processor with appropriate instructions for controlling the processor. The singular terms “server,” “computer,” and “system” should also be understood to refer to multiple hardware devices acting in concert with one another, e.g., multiple personal computers in a network; one or more personal computers in conjunction with one or more other devices, such as a router, hub, packet-inspection appliance, or firewall; a residential gateway coupled with a set-top box and a television; a network server coupled to a PC; a mobile phone coupled to a wireless hub; and the like. The term “processor” should be construed to include multiple processors operating in concert with one another.

It should also be appreciated from the outset that one or more of the functional components may alternatively be constructed out of custom, dedicated electronic hardware and/or software, without departing from the present disclosure. Thus, embodiments of the disclosure are intended to cover all such alternatives, modifications, and equivalents as may be included within the spirit and broad scope of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments.

Although the disclosure has been set forth in terms of the exemplary embodiments described herein and illustrated in the attached documents, it is to be understood that such disclosure is purely illustrative and is not to be interpreted as limiting. Consequently, various alterations, modifications, and/or alternative embodiments and applications may be suggested to those skilled in the art after having read this disclosure. Accordingly, it is intended that the disclosure be interpreted as encompassing all alterations, modifications, or alternative embodiments and applications as fall within the true spirit and scope of this disclosure.

It will be further understood that various changes in the details, materials, and arrangements of the parts which have been described and illustrated in order to explain the nature of this disclosure may be made by those skilled in the art without departing from the scope of the disclosure as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

I claim:

1. A processor-implemented method for encouraging a user of a computing device to perform a task, wherein the task includes the user providing input to the computing device and is divisible into a plurality of portions performable by the user at different times, the method comprising:
(a) the processor dividing the task into a plurality of portions;
(b) the processor waiting for one or more conditions to be satisfied;
(c) after the one or more conditions are satisfied, the processor prompting the user to provide a response; and
(d) after receiving the response from the user, the processor executing a software routine that enables the user to perform one of the portions of the task.

2. The method of claim 1, wherein the input is used by the computing device to process a plurality of media items comprising still images, moving video content, and/or audio content.

3. The method of claim 2, wherein step (a) comprises dividing the task by dividing the plurality of media items into smaller groups, and step (d) comprises enabling the user to perform a portion of the task corresponding to the media items in one of the groups.

4. The method of claim 1, wherein step (a) comprises dividing the task into a plurality of time periods.

5. The method of claim 1, wherein the one or more conditions include at least one condition based on date, time, or a time interval.

6. The method of claim 1, wherein the one or more conditions include at least one condition based on idleness of the user, usage of the processor, or usage of another resource of the computing device.

7. The method of claim 1, further comprising, after step (c) and before step (d), the processor prompting the user to specify a future time for the processor to prompt the user again to provide a response.

8. The method of claim 1, wherein prompting the user for a response comprises displaying to the user a prompt on a display of the computing device, and the response comprises the user responding to the prompt by providing input to the computing device.

9. The method of claim 1, wherein prompting the user for a response comprises providing a link to the user, and the response comprises the user employing the link to connect, using a web browser, to a web site.

10. The method of claim 1, further comprising, prior to step (a), the processor receiving a portion size provided as input by the user, wherein step (a) comprises dividing the task into portions based on the portion size provided by the user.

11. A system for encouraging a user to perform a task, wherein the task includes the user providing input to a user interface of the system and is divisible into a plurality of portions performable by the user at different times, the system comprising:
a user interface;
a processor; and
a non-transitory storage medium containing instructions for the processor, wherein, when the processor executes the instructions, the system is adapted to:
(a) divide the task into a plurality of portions;
(b) wait for one or more conditions to be satisfied;
(c) after the one or more conditions are satisfied, prompt the user to provide a response; and
(d) after receiving the response from the user, execute a software routine that enables the user to perform, via the user interface, one of the portions of the task.

12. The system of claim 11, wherein the input is used by the computing device to process a plurality of media items comprising still images, moving video content, and/or audio content.

13. The system of claim 12, wherein step (a) comprises dividing the task by dividing the plurality of media items into smaller groups, and step (d) comprises enabling the user to perform a portion of the task corresponding to the media items in one of the groups.

14. The system of claim 11, wherein step (a) comprises dividing the task into a plurality of time periods.

15. The system of claim 11, wherein the one or more conditions include at least one condition based on date, time, or a time interval.

16. The system of claim 11, wherein the one or more conditions include at least one condition based on idleness of the user, usage of the processor, or usage of another resource of the computing device.

17. The system of claim 11, wherein the system is adapted, after step (c) and before step (d), to prompt the user to specify a future time for the processor to prompt the user again to provide a response.

18. The system of claim 11, wherein prompting the user for a response comprises displaying to the user a prompt on a display of the computing device, and the response comprises the user responding to the prompt by providing input to the computing device.

19. The system of claim 11, wherein prompting the user for a response comprises providing a link to the user, and the response comprises the user employing the link to connect, using a web browser, to a web site.

20. The system of claim 11, wherein the system is adapted, prior to step (a), to receive a portion size provided as input by the user, wherein step (a) comprises dividing the task into portions based on the portion size provided by the user.

21. A non-transitory machine-readable storage medium, having encoded thereon program code, wherein, when the program code is executed by a machine, the machine implements a method for encouraging a user of a computing device to perform a task, wherein the task includes the user providing input to the computing device and is divisible into a plurality of portions performable by the user at different times, the method comprising:
(a) dividing the task into a plurality of portions;
(b) waiting for one or more conditions to be satisfied;
(c) after the one or more conditions are satisfied, prompting the user to provide a response; and
(d) after receiving the response from the user, executing a software routine that enables the user to perform one of the portions of the task.
